(19) United States
(12) Patent Application Publication
(10) Pub. No.: US 2026/0289140 A1
(43) Pub. Date: Sep. 24, 2026

(54) SYSTEM

(71) Applicant: SoftBank Group Corp., Tokyo (JP)

(72) Inventor: Kimihiro HAYASHI, Tokyo (JP)

(73) Assignee: SoftBank Group Corp., Tokyo (JP)

(21) Appl. No.: 19/568,909

(22) Filed: Mar. 17, 2026

(30) Foreign Application Priority Data
Mar. 19, 2025 (JP) 2025-045259

(51) Int. Cl. G06F 40/30; G06N 3/0475

(52) U.S. Cl. CPC G06F 40/30; G06N 3/0475

(57) ABSTRACT

A system includes a processor that is configured to receive, from a user, input indicating a current situation of the user and a question from the user, analyze information included in the input, recognize an emotional state of the user by using a generative artificial intelligence model based on a result of the analysis, and propose, based on the result of the analysis, an optimal use of time according to a life schedule and a goal of the user and provide step-by-step guidance toward achievement of the goal.

### CROSS-REFERENCE TO RELATED APPLICATION

This application is based on and claims priority under 35 USC 119 from Japanese Patent Application No. 2025-045259 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional time-management and goal-achievement support systems typically generate schedules or task lists based only on objective factors such as available time slots, deadlines, and task priority. Such systems generally ignore the emotional state of the user, including motivation, stress, anxiety, or fatigue. As a result, conventional systems may propose plans that are theoretically optimal in terms of time allocation but are practically difficult for the user to follow, leading to low adherence, frustration, and eventual abandonment of the plan.

Further, known systems often provide static or rigid step-by-step guidance that does not dynamically change in response to fluctuations in the user's emotional state. Even when a user's motivation decreases or stress increases, the system may continue to present the same level of task load or the same type of guidance, which can exacerbate the burden on the user and reduce the effectiveness of the support.

In addition, conventional systems tend to lack a mechanism that analyzes a user's free-text input in a comprehensive manner and recognizes, by using a generative artificial intelligence model, the user's emotional state embedded in the input. Without such emotional recognition, it is difficult to appropriately adapt proposals for optimal use of time and guidance toward goal achievement to the user's real, moment-by-moment condition.

Therefore, there is a need for a system that can analyze user input including the current situation and questions, recognize the user's emotional state by using a generative artificial intelligence model, and, based on this recognition, propose an optimal use of time that is tailored to the user's life schedule and goals, while also providing and dynamically adjusting step-by-step guidance toward achievement of those goals.

### SUMMARY

In order to solve the above-described problems, according to one aspect, a system is provided comprising a processor, wherein the processor is configured to receive, from a user, input indicating a current situation of the user and a question from the user, analyze information included in the input, recognize an emotional state of the user by using a generative artificial intelligence model based on a result of the analysis, and propose, based on the result of the analysis, an optimal use of time according to a life schedule and a goal of the user and provide step-by-step guidance toward achievement of the goal.

In the system, the processor is further configured to adjust a proposal for time management based on the emotional state of the user. For example, when the emotional state indicates low motivation or high stress, the processor may reduce the task load, insert rest periods, or prioritize simpler tasks. When the emotional state indicates high motivation or positive engagement, the processor may increase the intensity or difficulty of proposed tasks or accelerate progress toward the goal. By dynamically adjusting time-management proposals according to the recognized emotional state, the system can improve the practicality and adherence of the generated schedule.

In addition, the processor is further configured to adjust the step-by-step guidance toward achievement of the goal based on the emotional state of the user. For example, when the emotional state indicates anxiety or uncertainty, the processor may provide more detailed, finely divided steps and additional explanatory messages. When the emotional state indicates confidence and stability, the processor may present higher-level steps or more autonomous modes of guidance. By adapting the level, content, and tone of step-by-step guidance in accordance with the user's emotional state, the system can provide more appropriate and supportive navigation toward goal achievement.

Thus, by integrating analysis of user input, emotional-state recognition using a generative artificial intelligence model, and dynamic adjustment of both time-management proposals and step-by-step guidance, the system enables personalized and emotionally aware support for the user's life schedule and goals.

The term “processor” refers to any hardware or combination of hardware and software, including but not limited to a central processing unit (CPU), microprocessor, microcontroller, or specialized processing circuitry, that executes instructions to perform the functions described in the present specification and claims.

The term “user” refers to an individual person who operates a terminal or interacts with the system, and from whom the system receives input such as a current situation, questions, and goals.

The term “current situation” refers to information indicating a present state or context of the user, including but not limited to the user's personal, professional, educational, or lifestyle circumstances as described in the user's input.

The term “question” refers to any inquiry, request, or prompt provided by the user to the system, including but not limited to questions about time management, goal achievement, planning, or personal concerns.

The term “input” refers to data provided by the user to the system, including but not limited to free-text descriptions, selections, or other user interface interactions that indicate the current situation of the user and questions from the user.

The term “analyze” refers to processing input information by the processor, including but not limited to parsing, classifying, extracting features, or otherwise interpreting the content of the input in order to derive one or more analysis results.

The term “emotional state” refers to a psychological condition of the user inferred from the user's input, including but not limited to levels or types of emotion such as motivation, stress, anxiety, satisfaction, fatigue, or other affective states.

The term “generative artificial intelligence model” refers to a machine learning model configured to generate or transform data, such as text or representations thereof, based on learned patterns from training data, and that is capable of being used to recognize or infer the emotional state of the user from the user's input.

The term “life schedule” refers to a temporal structure of activities in the user's daily, weekly, or longer-term life, including but not limited to wake-up times, sleep times, work hours, study hours, and other recurring or planned activities.

The term “goal” refers to a target state or outcome that the user intends to achieve, including but not limited to professional objectives, personal development objectives, health-related objectives, or habit-formation objectives.

The term “optimal use of time” refers to an allocation or arrangement of time proposed by the system that is determined, based on the analysis result and recognized emotional state, to be suitable or preferable for the user in view of the user's life schedule and goal.

The term “time management” refers to planning, allocation, and adjustment of time periods for various activities of the user, including but not limited to work, study, rest, and goal-related tasks, as proposed or modified by the system.

The term “step-by-step guidance” refers to a sequence of instructions, recommendations, or action items presented in ordered steps, which guide the user progressively toward achievement of the goal.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

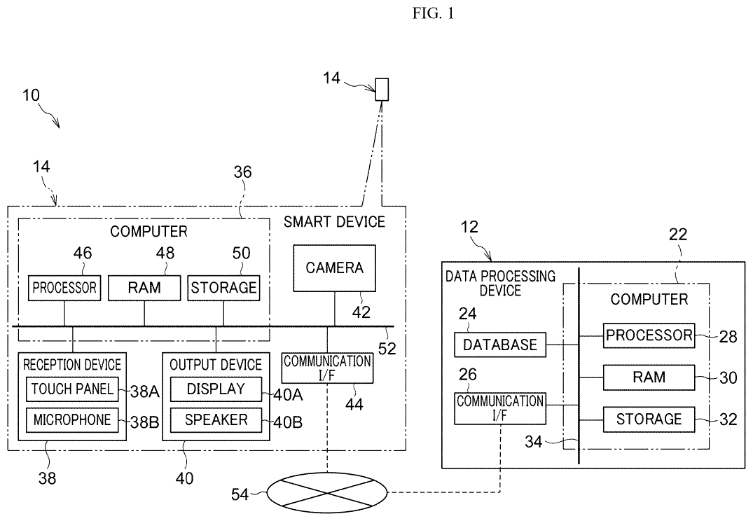

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

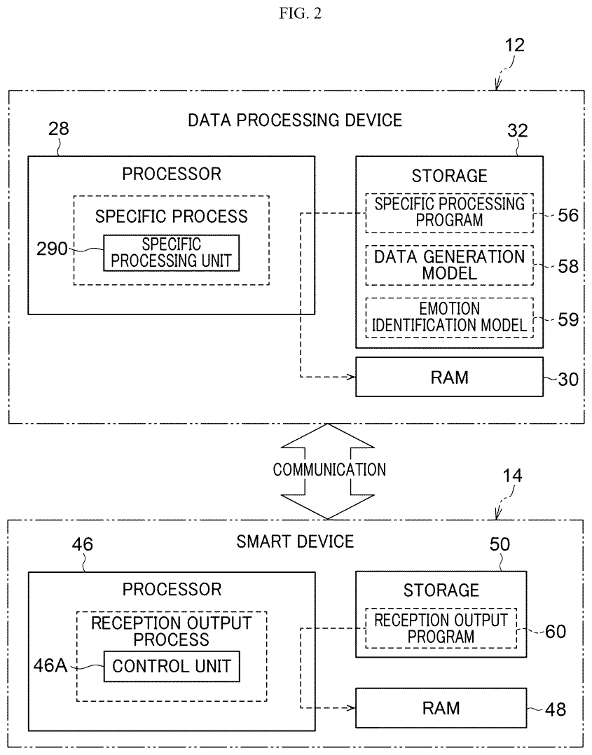

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented goal management and scheduling systems typically rely on fixed rule sets, static templates, or simple keyword-based logic to generate recommendations. These systems often process user input in an ad hoc manner without converting the input into rich structured data or context-aware prompts suitable for a generative AI model. As a result, the generated recommendations tend to be generic, lack personalization, and do not effectively adapt to the user's changing context, such as temporal constraints, external conditions, or past behavior history.

Moreover, existing systems that utilize machine learning or generative AI models usually invoke such models in a stateless or minimally stateful fashion. The systems generally provide only the latest user input as a model input, without systematically incorporating historical records of prior outputs, user progress, feedback, or external data into a machine-readable prompt sentence. This architecture leads to inefficient usage of computational resources because the generative AI model repeatedly reconstructs context from scratch, and it limits the continuity and coherence of the advice across multiple interactions.

Further, in many known architectures, user interaction data and model output are stored merely as unstructured logs or plain text. Such storage formats hinder efficient similarity search and retrieval of relevant past cases. Consequently, the system cannot easily reuse or refine previously generated plans, nor can it leverage accumulated historical patterns to improve the quality and stability of subsequent generations. This leads to redundancy in computation, slower response times, and suboptimal personalization.

Additionally, conventional systems do not adequately integrate heterogeneous external data sources—such as location information, calendar information, weather information, and route information—into the generative process in a structured and unified manner. In many cases, such data is either ignored or loosely appended to user-visible text, rather than being carefully embedded into a structured prompt sentence that is optimized for machine interpretation. This results in limited context-awareness and reduces the practical relevance of generated advice, especially for time- and place-dependent goals like daily exercise, commuting routines, or outdoor activities.

There is also a technical limitation in existing systems regarding adaptive control and continual optimization of the generative AI model's input. Specifically, current approaches lack a systematic mechanism by which the server dynamically updates the content of the prompt sentence and an extended prompt sentence based on user behavior records, feedback signals, and computed goal achievement levels. Without such a mechanism, the system cannot effectively adjust the granularity, difficulty, or time allocation of the generated action plans in response to the user's evolving state.

Accordingly, there is a need for an improved computer-implemented system that: (i) transforms raw user input into structured data and rich prompt sentences; (ii) augments such prompt sentences with external contextual data and user history in a machine-optimized format; (iii) uses a generative AI model to generate detailed advice and action plan information; and (iv) continuously refines subsequent prompt sentences based on stored generation results, similarity search, behavior records, and feedback. Such improvements would enhance the technical functioning of the server, improve resource utilization of the generative AI model, and provide more coherent, context-aware, and user-specific guidance over time.

The specific processing by the specific processing unit 290 of the data processing device 12 in Example 1 is realized by the following means.

The present invention provides a server comprising a processor and a storage device, the processor being configured to acquire, from a terminal, information including a goal and a current situation of a user, store the information as structured data in the storage device, classify, based on the structured data, a type of the goal, temporal conditions, and behavior history of the user, generate a prompt sentence including an input text for a generative AI model, generate an extended prompt sentence for input to the generative AI model by adding, to the prompt sentence, externally acquired data relating to at least one of location information, calendar information, weather information, route information, learning history information, and progress information of the user, input the extended prompt sentence into the generative AI model and execute inference processing to acquire a generation result including advice information and action plan information, analyze and structure the generation result as at least one of summary information, daily action information, weekly action information, schedule information, resource information, and motivational information, format the structured result as display data, transmit the display data to the terminal, and further acquire behavior record information and feedback information of the user from the terminal, update contents of the prompt sentence and the extended prompt sentence based on the behavior record information and the feedback information, store the generation result as record information in the storage device, and perform similarity search or history reference on the record information to incorporate a past generation result into a subsequent prompt sentence. This enables the server to improve computer-implemented processing for personalized guidance by systematically transforming user input and external context into optimized prompt sentences, efficiently controlling inference by the generative AI model with stateful and context-rich inputs, reusing stored generation results through similarity-based retrieval, and continuously adapting generated advice and action plans to the user's evolving state, thereby enhancing computational efficiency, responsiveness, and technical quality of the generated recommendations.

The term “processor” refers to a hardware or virtual processing unit, such as a central processing unit or a dedicated computing core, that executes instructions to perform the functions described in the present specification and claims.

The term “terminal” refers to an information processing device operated by a user, such as a mobile communication device, a portable computing device, or a stationary computing device, that is capable of transmitting data to and receiving data from a server.

The term “user” refers to a human operator who interacts with the terminal and the server by providing input information, receiving generated information, and optionally providing behavior record information and feedback information.

The term “goal” refers to a target state or desired outcome specified by the user, including but not limited to objectives related to work, study, health, finance, or lifestyle.

The term “current situation” refers to information indicating a present state of the user, including at least one of schedule information, constraints, environment, preferences, and capabilities relevant to the goal.

The term “structured data” refers to data that is organized according to a predetermined format or schema, such as a record, an object, or a data structure with defined fields and types, enabling systematic processing by the processor.

The term “storage device” refers to a hardware or virtual data storage component, such as a non-volatile memory device, a volatile memory device, or a storage system, that stores structured data, record information, and generation results.

The term “temporal conditions” refers to time-related constraints or attributes associated with the goal, including at least one of deadlines, target periods, daily or weekly time slots, and frequency of actions.

The term “behavior history” refers to accumulated information about past actions, interactions, or plan executions of the user, including at least one of completed tasks, skipped tasks, and modification records.

The term “prompt sentence” refers to a machine-readable text sequence generated by the processor that describes at least the goal and the current situation of the user and is configured as an input to a generative AI model.

The term “extended prompt sentence” refers to a prompt sentence to which additional contextual information, including externally acquired data and user history information, has been added so as to provide a richer and more detailed input to a generative AI model.

The term “generative AI model” refers to an artificial intelligence model, such as a neural network-based language model, that generates output data including natural language text in response to an input prompt sentence.

The term “inference processing” refers to computation performed by the generative AI model in response to an input prompt sentence or an extended prompt sentence to generate an output including advice information and action plan information.

The term “generation result” refers to data outputted from the generative AI model as a result of inference processing, including at least one of advice information, action plan information, and explanatory information.

The term “advice information” refers to generated information that provides recommendations, suggestions, or guidance to the user in relation to the goal and the current situation.

The term “action plan information” refers to generated information that specifies concrete actions, steps, or schedules for the user to follow in order to progress toward the goal.

The term “summary information” refers to generated information that provides an overview or concise description of the goal, the strategy, or the main points of the action plan.

The term “daily action information” refers to generated information that specifies actions or tasks to be performed on a daily basis by the user.

The term “weekly action information” refers to generated information that specifies actions or tasks to be performed within a weekly time frame or for each week.

The term “schedule information” refers to generated information that associates actions or tasks with particular dates, times, or time intervals.

The term “resource information” refers to generated information that identifies or recommends external or internal resources, such as materials, tools, or services, that assist the user in executing the action plan.

The term “motivational information” refers to generated information that is intended to encourage, support, or maintain the motivation of the user in relation to the goal.

The term “display data” refers to data formatted for presentation on a terminal, including structured or unstructured text, symbols, and other elements, such that the terminal can visually present the data to the user.

The term “location information” refers to data indicating a geographical position associated with the user, such as a coordinate, an address, or a region.

The term “calendar information” refers to temporal data obtained from a calendar source, including at least one of dates, holidays, events, and appointments relevant to the user.

The term “weather information” refers to meteorological data for a location relevant to the user, including at least one of temperature, precipitation, and weather forecasts.

The term “route information” refers to data representing one or more paths or courses, including at least one of travel routes, walking routes, distances, and estimated times.

The term “learning history information” refers to data representing a history of learning-related activities of the user, including at least one of studied topics, completed lessons, and test results.

The term “progress information” refers to data indicating a degree of advancement of the user toward the goal, including at least one of completed portions, remaining portions, and achievement ratios.

The term “behavior record information” refers to data representing actual actions taken by the user in relation to a generated plan, including at least one of completion flags, timestamps, and modification operations.

The term “feedback information” refers to data indicating evaluations, comments, preferences, or reactions of the user concerning generated advice information, action plan information, or system behavior.

The term “record information” refers to stored information including at least one of input information, generation results, behavior record information, and feedback information, which is retained in the storage device for later reference or processing.

The term “similarity search” refers to a retrieval process in which the processor identifies one or more record information entries that are similar to a query based on a similarity measure, such as a distance metric or a correlation measure applied to textual or vector representations.

The term “history reference” refers to a retrieval process in which the processor refers to past record information associated with the same user or similar goals, without necessarily computing a similarity metric, in order to reuse or adapt previous results.

The term “category information” refers to information indicating a classification of a goal or a plan into one or more predefined or dynamically determined categories, such as type of activity, domain, or priority.

The term “achievement information” refers to information indicating a level or degree of goal attainment by the user, including at least one of progress scores, completion rates, and achievement statuses.

In one embodiment, the system includes a server, a plurality of terminals, and at least one network. The server includes a processor and a storage device. The terminals include a processor, a display, an input interface, a memory, and a communication interface. The server and the terminals communicate via a packet-based network using a transport protocol such as TCP/IP over a secure channel such as HTTPS with TLS.

The terminal executes an application on hardware such as a smartphone, a tablet device, or a personal computer. The terminal uses an operating system such as a mobile operating system, a desktop operating system, or a browser runtime, and a graphical user interface framework such as a native UI toolkit or a web UI toolkit, to render screens for text input and plan visualization. The user operates the terminal to input text data representing a goal and a current situation. For example, the user inputs a sentence such as “I want to become a commercial airline pilot” or “I want to walk for 30 minutes every morning.”

The terminal converts the text input into structured data according to a predefined schema. The terminal generates a data object including at least fields for a user identifier, a goal string, a current situation string, a time stamp, and device context information (such as time zone and language setting). The terminal uses a data serialization library, such as a general-purpose JSON processing library, to encode the data object into a serialized representation. The terminal encrypts the serialized data using a transport layer security protocol and transmits the encrypted data to the server using an HTTP client library over the network.

The server receives the encrypted data through a network interface and a web-server component. The server terminates the secure transport session, decrypts the data stream, and passes an HTTP request to an application framework. The server uses a parsing library to decode the serialized representation into an internal structured representation, such as an in-memory object with fields corresponding to user identifier, goal, current situation, and associated metadata.

The server stores the structured representation in the storage device. The storage device includes a database system, which can be a relational database management system or a document-oriented database. The server defines a schema including a table or collection for user goals, another table or collection for generated plans, and another table or collection for behavior records and feedback. Each record includes references to user identifiers, textual content, goal categories, time stamps, and embedding vectors as described below.

The server classifies the user's goal into one or more categories. The server may use a hybrid method combining rule-based keyword detection and a light-weight classification model. In one example, the server applies a dictionary-based matcher to detect terms associated with “career,” “health,” “study,” “finance,” or “lifestyle.” In another example, the server applies a shallow neural network or a logistic regression classifier that operates on precomputed text embeddings to assign a category label. The server stores the category label as category information associated with the user's input.

The server computes temporal conditions for the goal. The server parses the current situation string and, where present, a target period or deadline, using a natural language date parser. The server converts expressions such as “within six months” or “every morning” to normalized time representations, such as a start date, an end date, and a recurrence pattern. The server stores the temporal conditions as additional fields associated with the structured representation.

The server maintains behavior history and progress information. When the user later reports completed tasks or when the terminal automatically records a completion, the terminal transmits behavior record information including a task identifier, a completion flag, and a completion time to the server. The server stores this behavior record information in the storage device, linked to the corresponding user identifier and goal. The server periodically computes achievement information, such as a completion rate or an achievement score, by aggregating the behavior record information for each goal.

The server generates a prompt sentence configured as input to a generative AI model. The server uses a prompt template stored in the storage device. The template includes sections for “User goal,” “Current situation,” “Temporal constraints,” “History summary,” “Output format requirement,” and “Constraints.” The server programmatically inserts the goal string, current situation string, category information, temporal conditions, and a summary of behavior history into this template.

For example, the server generates a prompt sentence such as:
“User goal: The user wants to become a commercial airline pilot.

Current situation: Age 22, university student in engineering, no flight experience, lives near a major city.

Temporal constraints: The user aims to start working as a commercial pilot within 5 years.

History summary: No prior aviation training has been recorded.

Task: Create a detailed multi-year roadmap to become a commercial airline pilot. Include required licenses, recommended training sequence, approximate timelines, exam preparation strategies, and weekly study/practice actions.

Constraints: Explain in simple language suitable for a beginner. Organize the answer into sections: Overview, Year-by-Year Plan, Weekly Habits, Recommended Resources.”

In another example, the server generates a prompt sentence such as:
“User goal: The user wants to walk for 30 minutes every morning.

Current situation: Works from 9:00 to 18:00, lives in a city apartment, usually wakes up at 7:00.

Temporal constraints: The user wants to start this habit from next Monday and continue for at least 4 weeks.

History summary: No regular walking habit recorded in the past month.

Task: Design a realistic 7-day walking plan. For each day, specify a recommended start time, an example route type (e.g., park, riverside, residential streets), and adjustments for rainy or very hot days.

Output format: Use bullet points by day, and add 1-2 motivational tips at the end.”

The server further generates an extended prompt sentence by incorporating external data. The server may query one or more external information sources, such as a calendar service, a meteorological information service, or a route information service. For example, the server obtains a 7-day weather forecast for the user's location and a set of candidate walking routes with distances and estimated times. The server formats this external data into textual segments under headings such as “External data” and appends them to the prompt sentence to create the extended prompt sentence. Because the external data are structured and normalized in machine-readable form before conversion to text, the generative AI model receives a consistent, context-rich representation that supports accurate reasoning and reduces ambiguity.

The server inputs the extended prompt sentence into the generative AI model and executes inference processing. In one embodiment, the generative AI model includes a neural network using a transformer architecture, comprising an embedding layer, a plurality of self-attention layers, feedforward layers, and an output projection layer. The server tokenizes the extended prompt sentence using a subword tokenization algorithm and maps tokens to embedding vectors. The server then processes the sequence of embedding vectors through multiple attention heads in each layer, applying linear transformations and non-linear activation functions. The server uses pre-trained parameters, which were obtained by training the model on a large corpus of text data, and may optionally fine-tune the model on domain-specific training data derived from anonymized user interactions.

During inference, the server specifies generation parameters such as maximum token length, temperature, and top-k or top-p sampling thresholds. These parameters control computational load and diversity of generated text. The server receives a sequence of output token identifiers from the generative AI model and decodes them to a text string, which constitutes the generation result. The generation result includes advice information and action plan information as required by the prompt sentence.

The server analyzes the generation result and structures it into multiple fields. The server applies deterministic rules, such as detection of headings and list markers, and pattern matching to extract segments corresponding to summary information, daily action information, weekly action information, schedule information, resource information, and motivational information. The server builds an internal structured representation in which each segment is assigned to a specific field. The server may also normalize time expressions and convert them into explicit date-time objects using the same date parser used for temporal conditions.

The server stores the structured generation result as record information in the storage device. The server computes a vector representation (embedding) of at least the goal description and the summary information by applying a text embedding model. The server stores the embedding vector along with an identifier of the record information. The server then registers the embedding in a similarity-search index, such as a vector index stored in specialized data structures optimized for nearest-neighbor search. This structure enables the server to efficiently retrieve similar past generation results based on vector similarity instead of simple keyword matching.

When the user later submits a new goal or modifies an existing goal, the server performs similarity search against the stored record information. The server compares the embedding vector of the new input with previously stored vectors, computes a similarity measure such as cosine similarity, and retrieves one or more similar plans. The server then incorporates summaries or selected segments from the similar plans into the new prompt sentence. This reuse of structured generation results reduces redundant computation by the generative AI model, improves response time, and increases consistency and continuity of guidance across sessions.

The server continuously updates the prompt sentence and extended prompt sentence based on behavior record information and feedback information. For example, when the user repeatedly fails to complete certain daily tasks, the terminal transmits negative feedback or low completion rates. The server aggregates this information and adjusts internal control variables such as difficulty level, daily workload, and time allocation patterns. The server explicitly encodes these control variables in the prompt sentence, for instance by adding a clause such as “Reduce the daily study time to 30 minutes and prioritize essential topics, because the user has not been able to complete longer sessions.” By doing so, the system uses the generative AI model in a non-conventional, stateful manner where input prompts are algorithmically shaped by machine-generated and human-generated feedback rather than by human authors alone.

The terminal receives the display data from the server, decodes it using the same serialization library, and renders each field using specific user interface components. The terminal may display summary information at the top of a screen, followed by a list of daily actions with checkboxes, a calendar view for weekly action information, and separate sections for resource information and motivational information. The terminal may locally cache a portion of the display data to reduce repeated communication with the server.

The user views the display data and performs real-world actions according to the action plan information. For example, the user may enroll in a training course, follow a suggested walking route, or prepare specific meals according to a dietary plan. After performing or skipping actions, the user uses the terminal to mark items as completed, postponed, or canceled, and optionally enters comments. The terminal converts these interactions into behavior record information and feedback information and sends them to the server. This loop enables the server to refine subsequent plans and adjust the generative AI model's inputs in a way that improves alignment with the user's actual behavior.

The server executes various optimization techniques to improve computational efficiency. The server may cache embeddings of frequently appearing goal descriptions, reuse partial results from the generative AI model for similar prompts, and limit generation length by requesting the model to output structured summaries rather than verbose narratives. The server may also compress stored record information and perform index pruning in the similarity search index to avoid excessive memory usage. These measures reduce processing time and resource consumption while maintaining or improving output quality.

The system as implemented in this manner improves computer technology beyond mere automation of human planning. The server introduces a specific data structure pipeline—raw text input, structured data, classified categories, temporal conditions, extended prompt sentences, structured generation results, and vector-indexed record information—that is optimized for interaction with a generative AI model. By integrating similarity-based retrieval, stateful prompt generation, and explicit feedback-driven adjustment, the server reduces redundant neural network computation, improves cache locality, and increases the effective utilization of model parameters. The extended prompt sentence with external data reduces the need for the model to infer context from incomplete input, thereby decreasing hallucination and error rates.

The generative AI model is trained using supervised fine-tuning and optionally reinforcement learning from human feedback. During training, the model minimizes a loss function such as cross-entropy between predicted token distributions and reference tokens. A gradient-based optimization algorithm, such as a variant of stochastic gradient descent with adaptive learning rates, updates the model weights. The training data may include pairs of prompt sentences and preferred responses, where responses are rated or ranked by human evaluators. The server may further perform domain-specific fine-tuning by sampling anonymized plans and feedback stored in the storage device, creating augmented training examples that reflect real-world usage distributions.

The use of embeddings and similarity search represents a non-conventional data management technique relative to simple logging. By converting high-dimensional text into dense vectors and indexing them, the server enables fast retrieval of semantically related records, which in turn allows the prompt sentence to incorporate proven subplans rather than regenerating all content. This reduces latency and computation load on the generative AI model, directly improving processing speed and scalability.

In alternative embodiments, the server may deploy different types of generative AI models, such as encoder-decoder architectures or smaller domain-specific models, while maintaining the same structured prompt generation and similarity search mechanism. The server may adjust the internal schemas (for example, adding fields for monthly action information or long-term milestone information) without altering the fundamental pipeline. The terminal may be integrated into other devices, such as wearable devices or in-vehicle systems, as long as the terminal is capable of sending structured user input and receiving and rendering display data.

In another embodiment, the server may execute a rule-based post-processor that checks the consistency of the model output against external constraints (such as maximum daily time limits or safety guidelines) and modifies or rejects certain parts of the output. This post-processing can use deterministic algorithms running on the processor, further strengthening technical reliability and reducing the risk of erroneous recommendations.

By combining these modules—the input structuring module, the classification and temporal analysis module, the prompt and extended prompt generation module, the generative AI inference module, the result structuring module, the storage and similarity search module, and the feedback-adaptive control module—the system provides a concrete, technically detailed implementation that improves how a computer server generates, manages, and refines personalized action plans. The result is improved accuracy, reduced computation time, better data management, and enhanced technical quality of recommendations compared to conventional rule-based or stateless AI systems.

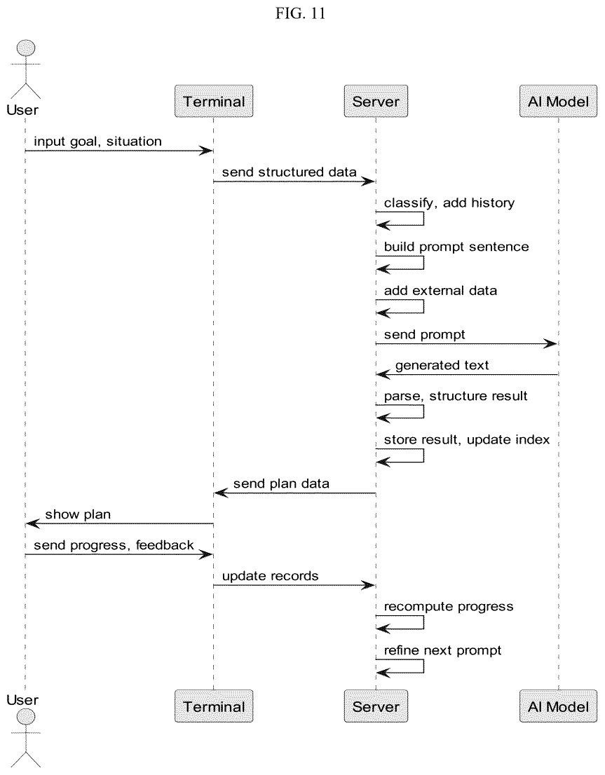

The following describes the processing flow using FIG. 11.

### Step 1:

The user operates the terminal to start an application and input information. The user views an input screen and types a goal and a current situation into text fields, for example, “I want to become a commercial airline pilot” as the goal and “I am 22, a university student, and I have no flight experience” as the current situation. The input consists of raw character strings entered by the user. The output of this step is a set of raw text values held in the terminal's memory, associated with a user identifier and basic context such as language and time zone.

### Step 2:

The terminal converts the raw text into structured data. The terminal receives as input the raw goal text, the current situation text, and context information (user identifier, time stamp, device information). The terminal executes a data structuring process in which it creates an internal data object with defined fields, such as ‘goal’, ‘current_situation’, ‘user_id’, and ‘timestamp’. The terminal uses a serialization library to transform this internal object into a serialized representation, such as a JSON string or equivalent structured message. The output of this step is the serialized structured data ready for transmission.

### Step 3:

The terminal securely transmits the structured data to the server over the network. The terminal receives as input the serialized structured data. The terminal opens an HTTPS connection to a server address, performs a handshake for transport layer security, and encrypts the data stream. The terminal packages the serialized data into an HTTP request body and attaches headers such as content type and authentication tokens. The terminal sends the encrypted request to the server. The output of this step is an encrypted network packet stream containing the structured user input.

### Step 4:

The server receives the encrypted data and reconstructs the structured representation. The server receives as input the encrypted packets on a network interface. The server performs TLS termination to decrypt the packets and extracts the HTTP request. The server reads the request body and applies a parser compatible with the terminal's serialization format to decode the JSON or other structured message. The server constructs an internal data structure with fields such as goal, current situation, user identifier, and timestamp. The output of this step is a server-side internal representation of the user input and metadata.

### Step 5:

The server classifies the goal and computes temporal conditions. The server receives as input the internal representation of the user input. The server applies text analysis routines to the goal and current situation, including tokenization and keyword detection. The server may additionally compute an embedding vector of the goal text using a text embedding model. Based on keywords, patterns, and embedding similarity to known prototypes, the server assigns one or more category labels, such as “career,” “health,” or “study.” The server also parses date and time expressions in the current situation or in additional fields, using a natural language date parser, and converts them into normalized time structures, such as start date, end date, and recurrence pattern. The output of this step is an augmented data structure containing category information and temporal conditions in addition to the original user input.

### Step 6:

The server retrieves behavior history and progress information related to the same user and goal. The server receives as input the user identifier and the categorized goal information. The server executes database queries on the storage device to obtain prior behavior records for the user, such as completed actions, skipped actions, and timestamps, as well as previous plans and feedback entries. The server aggregates these records to compute progress metrics, such as completion rates and achievement scores, and generates a concise history summary, for example, “The user has completed 60% of the planned weekly tasks in the last two weeks.” The output of this step is a structured history summary and progress measures associated with the current goal.

### Step 7:

The server constructs a base prompt sentence for a generative AI model. The server receives as input the user goal, current situation, category information, temporal conditions, and the history summary. The server selects a prompt template designed for the relevant category and inserts the input fields into predetermined slots within the template. For example, for a career goal, the server arranges the data into sections called “User goal,” “Current situation,” “Temporal constraints,” “History summary,” “Task,” and “Constraints.” The server concatenates these sections as a single text string in natural language. The output of this step is a base prompt sentence that describes the user's state, constraints, and desired output format.

### Step 8:

The server augments the base prompt sentence with external contextual data to form an extended prompt sentence. The server receives as input the base prompt sentence and contextual identifiers such as the user's location, calendar, and goal category. The server issues requests to external services, for example, a weather information service to obtain a forecast or a route information service to obtain possible walking or commuting routes. The server converts the external data to normalized textual descriptions grouped under headings such as “External data: Weather forecast” and “External data: Suggested routes.” The server appends these descriptions to the base prompt sentence in a controlled format. The output of this step is an extended prompt sentence that includes both user-specific information and structured external context for use by the generative AI model.

### Step 9:

The server performs inference processing by the generative AI model using the extended prompt sentence. The server receives as input the extended prompt sentence. The server encodes the text by tokenizing it into subword tokens and mapping them to numerical token identifiers. The server passes the token identifiers to a generative AI model, for example a transformer-based language model, executed on a computation backend such as a GPU-accelerated runtime. The model processes the token sequence through multiple self-attention layers and feedforward layers, using pre-trained weight parameters, and sequentially predicts output token probabilities. The server samples or selects tokens according to configured parameters such as temperature and top-k or top-p values, thus generating a sequence of output tokens that represent the model's response. The server decodes the tokens back into a natural language text string. The output of this step is a generation result consisting of advice information and action plan information in text form.

### Step 10:

The server structures and normalizes the generation result. The server receives as input the raw text of the generation result. The server applies post-processing rules and parsing logic to identify sections and list items. For example, the server detects headings such as “Overview,” “Daily Plan,” or “Weekly Plan,” and list indicators such as bullets or numbers. The server splits the text into segments and assigns each segment to one or more fields: summary information, daily action information, weekly action information, schedule information, resource information, and motivational information. The server may further convert expressions like “every Monday at 7 a.m.” into precise date and time objects for upcoming weeks. The output of this step is a structured representation of the generation result suitable for storage and display.

### Step 11:

The server stores the structured generation result and computes an embedding for future retrieval. The server receives as input the structured result and associated metadata such as the user identifier, category information, and timestamps. The server inserts a new record into a storage structure, such as a database table, including fields for the original prompt sentence, the extended prompt sentence, the structured result, and behavior-related attributes. The server computes an embedding vector from selected text fields, for example from the goal and the summary information, using a text embedding model. The server registers the embedding in a similarity-search index that supports efficient nearest-neighbor queries. The output of this step is an updated storage state containing both symbolic and vector representations of the plan.

### Step 12:

The server prepares display data for the terminal. The server receives as input the structured generation result. The server converts internal fields into a client-facing data format, such as a JSON object with keys such as ‘summary’, ‘daily_actions’, ‘weekly_actions’, ‘schedule’, ‘resources’, and ‘motivation’. The server ensures that string lengths, field names, and nesting structures are compatible with the terminal application's rendering logic. The output of this step is serialized display data ready to be transmitted back to the terminal.

### Step 13:

The server transmits the display data to the terminal. The server receives as input the serialized display data and the network address associated with the terminal's request. The server embeds the display data into an HTTP response body and sets appropriate headers. The server encrypts the response using TLS and sends the encrypted packets over the network. The output of this step is an encrypted network stream containing the display data addressed to the terminal.

### Step 14:

The terminal receives the display data and renders it for the user. The terminal receives as input the encrypted network packets. The terminal performs TLS decryption, extracts the HTTP response, and parses the response body using its structured-data parser. The terminal converts the parsed data into internal objects and passes them to the user interface component. The terminal then renders summary information at the top of the screen and displays lists of daily and weekly actions, including checkboxes, timestamps, and buttons or links for resource information. The output of this step is an updated graphical display that visually presents the advice information and action plan information to the user.

### Step 15:

The user interacts with the displayed plan and provides behavior record information and feedback. The user receives as input the on-screen plan. The user inspects the suggested steps and, after performing or skipping actions in the real world, operates UI elements on the terminal to mark tasks as completed, postponed, or canceled, and optionally enters textual comments such as “Too difficult” or “Need shorter sessions.” The terminal collects these interaction events and converts them into structured behavior record information and feedback information, including task identifiers, completion flags, timestamps, and comment strings. The output of this step is a structured set of behavior and feedback records stored temporarily on the terminal.

### Step 16:

The terminal transmits the behavior record information and feedback information to the server. The terminal receives as input the structured behavior and feedback records. The terminal serializes these records into a structured message, encrypts the message using TLS, and sends it as an HTTP request to a server endpoint dedicated to progress updates. The output of this step is an encrypted network stream carrying updated behavior record information and feedback information.

### Step 17:

The server updates stored records and recalculates progress and control variables. The server receives as input the behavior record information and feedback information. The server decodes and parses the incoming data and writes new entries into the behavior-record storage structure, linking them to the appropriate user identifier and plan identifier. The server recomputes achievement information by aggregating completed and pending tasks, updates achievement scores, and adjusts internal control parameters such as recommended daily load, difficulty level, and time allocation factors. The output of this step is an updated internal state reflecting the user's latest behavior and calibrated control variables for future prompt generation.

### Step 18:

The server refines subsequent prompt sentences using stored history and similarity search. The server receives as input the updated internal state, including progress metrics and new behavior records. When the user initiates a new planning cycle, the server queries the similarity-search index using the current goal embedding or a composite embedding of the goal and recent history. The server retrieves one or more past generation results with high similarity, extracts reusable components such as subplans or resource lists, and incorporates them into a new prompt sentence. The server also encodes the updated control variables and feedback signals directly into the new prompt sentence as explicit instructions, such as “Reduce daily study time to 30 minutes due to low completion rate.” The output of this step is a revised prompt sentence or extended prompt sentence that is tailored to the user's evolving state and leverages prior generated content.

### Step 19:

The server repeats inference and update cycles to continuously optimize guidance. The server receives as input the refined prompt sentences generated after each update. The server executes further inference processing using the generative AI model, produces new generation results, structures and stores them, and sends corresponding display data to the terminal as described in previous steps. Over multiple cycles, the server uses accumulated record information, similarity search, and feedback-driven control to reduce redundant computation, improve alignment between suggested plans and actual behavior, and enhance the accuracy and usefulness of generated advice and action plans. The output of this step is a sequence of increasingly optimized plans delivered to the user through the terminal.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented goal support systems and scheduling tools typically rely on static rule sets or simple template-based logic to generate recommendations for time management and action planning. Such systems generally accept user goals and calendar data, and then apply pre-defined heuristics to produce fixed patterns of schedules or checklists. As a result, these systems suffer from several technical limitations.

First, conventional systems are not configured to transform unstructured natural language input about user goals and available time into rich, structured representations that can be dynamically adapted. Many existing implementations treat user input as plain strings and apply minimal parsing, which leads to information loss regarding contextual constraints, temporal expressions, and user-specific conditions. This coarse handling of input data results in low-quality downstream processing and restricts the ability of the system to generate diverse and tailored plans.

Second, existing systems generally do not exploit a generative AI model in a technically optimized manner. When such models are used, they are often invoked with ad hoc, manually crafted prompts that are not systematically derived from structured analysis of the user input. This leads to unstable response quality, inconsistent coverage of necessary steps, and ineffective use of computing resources on the server side, because the model is not guided by a well-formed, machine-generated prompt sentence that encodes the user's goal, constraints, and required output structure.

Third, conventional architectures lack an integrated mechanism to convert the free-form output of a generative AI model into structured data suitable for efficient rendering, interaction, and reuse across different terminal devices. In many cases, generated text is returned directly to a client as a monolithic string. This hinders the ability of the client to programmatically identify individual steps, time allocations, or categories and to present them in an optimized user interface. Consequently, client-side processing becomes more complex and less efficient, and server-side processing cannot reliably enforce a consistent data schema.

Fourth, conventional systems fail to integrate recognition of a user's emotional state at the level of prompt generation and output control in a technically meaningful way. While some user interfaces may collect subjective feedback, they do not use such information to adjust internal representations and prompt sentences that drive the generative AI model. As a result, the system cannot systematically modulate the granularity, tone, or intensity of the generated guidance in response to detected emotional states, thereby limiting both usability and system-level adaptability.

Accordingly, there is a need for an improved computer-implemented system that: (i) acquires goal information and time information as natural language input; (ii) performs natural language processing to generate structured information; (iii) automatically constructs a prompt sentence embedding conditions and constraints derived from the structured information; (iv) invokes a generative AI model with the constructed prompt sentence; and (v) post-processes the response text from the generative AI model into structured data formats optimized for transmission and visual presentation on terminals, while optionally adjusting these processes in accordance with an estimated emotional state of the user. Such an improved system would enhance the technical functioning of a server in processing natural language inputs and outputs, reduce ad hoc manual prompt engineering, and provide more consistent and efficient data handling for downstream applications.

The specific processing by the specific processing unit 290 of the data processing device 12 in Application Example 1 is realized by the following means.

The present invention provides a server comprising a processor configured to acquire goal information and time information of a user from a terminal as text information; execute natural language processing on the text information to perform token-level segmentation and semantic analysis to generate structured information including the goal information and the time information; automatically construct a prompt sentence that embeds conditions and constraints for achievement of the goal of the user based on the structured information; input the prompt sentence to a generative AI model and obtain, from the generative AI model, response text including optimal time usage and step-by-step guidance toward achievement of the goal; convert the response text into structured data including item information and time allocation information; format the structured data into a data format suitable for transmission to the terminal via a network; and transmit the formatted structured data to the terminal for visual presentation on the terminal. This enables an improved computer-implemented processing pipeline in which unstructured user input is transformed into structured prompt sentences and structured output data in an automated and technically consistent manner, thereby enhancing the efficiency, reliability, and adaptability of server-side natural language processing and generative AI model utilization.

The term “goal information” refers to information indicating an objective or desired state of a user, expressed in natural language, which the user intends to achieve over a period of time.

The term “time information” refers to information indicating temporal conditions or availability of a user, including durations, time slots, dates, or frequencies, expressed in natural language.

The term “terminal” refers to an information processing apparatus operated by a user, such as a computing device with an input unit, a display unit, and a communication unit, capable of transmitting and receiving data over a network.

The term “text information” refers to data composed of one or more character strings, typically representing natural language sentences, clauses, or phrases, which can be processed by a computer program.

The term “natural language processing” refers to a series of computational operations performed on text information to analyze linguistic structure and meaning, including but not limited to tokenization, part-of-speech tagging, syntactic parsing, semantic analysis, and entity recognition.

The term “token-level segmentation” refers to processing that divides text information into minimal linguistic units, such as words or subwords, which can be independently analyzed or processed by subsequent algorithms.

The term “semantic analysis” refers to processing that interprets the meaning of text information, including identification of relationships between tokens, extraction of entities, intents, constraints, and contextual attributes.

The term “structured information” refers to information represented in a predefined data format, such as a record, a table, or a hierarchical data object, in which elements such as goals, time constraints, and conditions are explicitly separated and labeled for computational use.

The term “prompt sentence” refers to a text string supplied as input to a generative AI model, the text string encoding instructions, conditions, constraints, and context necessary for the model to generate a desired output.

The term “conditions and constraints” refers to parameters or limitations derived from goal information and time information, including requirements, priorities, available time, and other contextual factors that influence the generation of guidance or recommendations.

The term “generative AI model” refers to a trained computational model that, given input information such as a prompt sentence, generates new text or content by probabilistic or statistical inference, using machine learning techniques.

The term “response text” refers to text generated and output by a generative AI model in response to a prompt sentence, the text including recommendations, plans, or other content relevant to the user's goal and constraints.

The term “optimal time usage” refers to a recommended allocation or scheduling of available time of a user, derived in consideration of the user's goal, constraints, and context, intended to improve efficiency or effectiveness in goal achievement.

The term “step-by-step guidance” refers to a sequence of ordered instructions or actions that a user is recommended to perform, each step being described so that the user can follow the sequence to progress toward a goal.

The term “structured data” refers to data in which content elements, such as items and time allocations, are organized in a machine-readable format with defined fields, keys, or indices, enabling systematic access and processing.

The term “item information” refers to individual units of content, such as steps, tasks, milestones, or categories, extracted or derived from response text and represented as discrete elements within structured data.

The term “time allocation information” refers to data indicating a distribution of time assigned to one or more items, including start times, end times, durations, frequencies, or periodic schedules.

The term “data format suitable for transmission” refers to a representation of structured data, such as a serialized object or message format, which complies with a communication protocol and can be transmitted over a network between devices.

The term “network” refers to a communication infrastructure that interconnects two or more devices, enabling data exchange via wired or wireless communication protocols.

The term “visual presentation” refers to display of information on a screen or other display apparatus in a human-perceptible form, such as text, lists, tables, or graphical elements, such that a user can recognize and comprehend the information.

The term “emotional state” refers to an estimated or inferred affective condition of a user, such as stress level, motivation, confidence, or mood, derived from textual input, model inference, or other signals.

The term “requested content” refers to a specification within a prompt sentence that indicates what type of information or output is to be generated by the generative AI model, such as descriptions, steps, schedules, or summaries.

The term “level of detail” refers to a degree of granularity or specificity of information requested or provided, including the number of sub-steps, the amount of explanation, and the precision of recommendations.

The term “instruction expressions” refers to linguistic forms used within a prompt sentence or response text to convey directives or recommendations, such as imperatives, suggestions, or procedural commands.

The term “number of steps” refers to a count of discrete guidance units or actions in a step-by-step guidance sequence, which can be adjusted according to user conditions or emotional state.

In one or more embodiments, a system implements the invention by using a server, one or more terminals, and a communication network connecting them. The server includes at least one processor, a memory, a non-transitory storage medium, and a network interface. The terminal includes a processor, a memory, a display unit, an input unit, and a network interface. The server executes a program stored in the memory to realize the functions described below. The terminal executes a client-side program, for example an application framework, to provide a user interface and to perform communication with the server.

The server uses general-purpose computing hardware, such as a multi-core central processing unit and, in some embodiments, a graphics processing unit or a tensor processing unit, hosted in a data center. The server stores and executes software components implemented using a general-purpose programming language and common libraries, including a web application framework, a natural language processing library, and an application programming interface client library for a generative AI model. The server uses a deep neural network-based generative AI model deployed on specialized inference hardware accessible via a network-based inference service. The server further maintains data structures in memory and in a database management system to store user-related information, intermediate structured representations, prompt sentences, and generated guidance data.

The terminal uses an operating system running on a mobile device or a personal computing device. The terminal executes a client application implementing a user interface library to render input fields, lists, and other widgets. The terminal communicates with the server using a secure transport protocol over the network. The terminal presents information on a display device using a graphical rendering engine and receives user input via a touch panel, a keyboard, a pointing device, or equivalent input hardware.

The user operates the terminal to input goal information and time information in natural language. The user inputs, for example, “I want to become a pilot. I am a university student and can study about 2 hours on weekdays and 4 hours on weekends.” The terminal converts the user input into text information, associates the text information with a user identifier and optional contextual attributes, and transmits the text information to the server via the network.

The server receives the text information and stores it in a buffer in the memory. The server uses a natural language processing library running on the processor to perform token-level segmentation, part-of-speech tagging, and semantic analysis. The server converts the raw text into a sequence of tokens, assigns part-of-speech tags, and builds a syntactic dependency graph. The server then executes semantic role labeling and entity recognition to detect entities such as professions, time durations, days of the week, and activity types. The server stores the results as structured information in an internal data structure, such as a hierarchical object containing fields for main_goal, time_constraints, current_status, and additional attributes such as domain_category or urgency_level.

The server uses this structured information to generate a prompt sentence for the generative AI model. The server uses a rule-based prompt constructor module that applies a plurality of templates and transformation rules. The server selects a base template according to the domain_category (for example, “career development,” “skill acquisition,” or “health improvement”), and inserts values from the structured information into predefined slots. The server further appends explicit instructions that define output sections, output style, and granularity. The prompt constructor module uses a deterministic algorithm based on string concatenation and conditional insertion, and avoids ad hoc manual prompt construction for each user. By constructing prompt sentences in this machine-driven and structured manner, the server reduces variability in input conditions to the generative AI model and improves the stability and predictability of generated outputs.

In one example, the server generates a prompt sentence such as:
“The user's main goal is to become a pilot. The user is currently a university student and can study about 2 hours on weekdays and 4 hours on weekends. As a generative AI model, provide a detailed, step-by-step roadmap for the user to become a pilot. Include major phases, specific actions, required licenses and examinations, recommended weekly study schedules that fit the user's available time, and key checkpoints for measuring progress. Write in clear and concise language that a non-expert can follow.”

In another example, when the user enters a language-learning goal, the server generates a prompt sentence such as:
“The user's main goal is to improve English conversation for business. The user works full-time and can study 1 hour on weekdays at night. As a generative AI model, create a 3-month learning plan with specific daily tasks, recommended practice methods, and weekly review checkpoints, tailored to this schedule.”

The server, in some embodiments, additionally uses features derived from the text information to infer an emotional state of the user. The server uses an emotion classification module implemented as a neural network model or a statistical classifier. The server uses text features such as token n-grams, sentiment scores, punctuation density, and syntactic patterns as input features. The emotion classification module outputs a set of scores corresponding to categories such as high_stress, low_motivation, or confident_state. The server encodes the emotional state as additional structured information. The server then adjusts the prompt sentence by altering the requested level of detail, the tone of instructions, or the number of steps. For instance, when the emotional state is high_stress, the server reduces the number of major steps, increases the granularity of short-term actions, and adds supportive phrasing instructions to the prompt sentence.

The server uses a generative AI model implemented as a deep neural network, for example a transformer-based network containing multiple attention layers, feedforward layers, and layer normalization units. The generative AI model is trained beforehand using a large corpus of text, using an objective function such as cross-entropy loss over token sequences. During training, the model adjusts internal weight parameters via gradient descent and backpropagation. The training process may include techniques such as learning rate scheduling, regularization, and data augmentation (for example, random masking and sequence permutation within allowable limits). The generative AI model uses a token embedding layer to convert input tokens in the prompt sentence into dense vector representations, applies self-attention across token positions, and produces an output distribution over tokens at each position. This architecture allows the model to capture long-range dependencies and context structure in the prompt sentence.

During inference, the server sends the tokenized prompt sentence to the generative AI model via an API endpoint exposed by an inference service. The server specifies generation parameters such as maximum output length, sampling temperature, and repetition penalty to control the quality and diversity of the generated text. The generative AI model executes feedforward computations on specialized hardware, such as graphics processing units or tensor processing units, to produce response text based on the prompt sentence. The server receives the response text as a sequence of tokens, decodes the tokens to characters, and reassembles them into sentences and paragraphs.

The server then post-processes the response text to convert it into structured data. The server uses pattern recognition, section headers indicated in the prompt sentence, and simple rule-based parsing to separate the response text into segments such as “Overview,” “Phase 1,” “Phase 2,” “Required skills,” and “Weekly schedule.” The server constructs a structured data object that includes item information (for example, steps, milestones, and recommended tasks) and time allocation information (for example, hours per day, days per week, or specific calendar periods). The server stores the structured data in a database or in memory and formats the structured data into a machine-readable format suitable for transmission over the network.

The terminal receives the structured data and updates a local state representation of the guidance content. The terminal renders the item information and the time allocation information on the display. The terminal uses visual hierarchy (such as headings, bullet lists, and timeline views) to present the structured data in a human-readable form. The user can scroll, expand, collapse, or filter sections of the guidance using the input unit. The terminal, through its rendering engine and layout algorithms, reduces cognitive load by grouping related steps and visually aligning time allocations with calendar views or progress bars.

The system provides several technical effects and improvements in computer technology. The server, by converting unstructured natural language input into structured information before constructing the prompt sentence, reduces the amount of redundant and ambiguous text sent to the generative AI model. This reduction leads to lower network bandwidth usage between the server and the inference service, and to reduced processing time in the generative AI model, thereby improving processing speed and reducing computational load.

The server also improves data management by storing intermediate structured representations. Because the server maintains explicit fields for goal information, time information, and emotional state, the server can reuse these fields across repeated interactions without re-parsing the entire history of user text. This reuse lowers processing overhead and enables incremental updates to prompt sentences. For example, when the user modifies the time information but not the main goal, the server only updates the time_constraints field and reconstructs the prompt sentence using existing goal-related fields, thereby avoiding redundant computations.

The server improves accuracy and consistency of generated guidance by enforcing a template-based, rule-driven prompt construction algorithm. Instead of relying on ad hoc human-authored prompts, the server uses deterministic rules to control the structure and content of the prompt sentence. This leads to more regular output structures from the generative AI model, which in turn allows the server to reliably parse output sections and convert them into structured data. This regularization reduces parsing errors, improves segmentation of steps and schedules, and facilitates programmatic validation of the generated guidance.

The server further improves computation efficiency by adapting the complexity and length of the prompt sentence and the output request in accordance with the emotional state of the user and the complexity of the goal information. For users with simple goals or limited available time, the server reduces the requested number of phases and the level of detail, resulting in shorter prompts and shorter generated outputs. This adaptive mechanism reduces unnecessary computational work on the generative AI model and lowers network load. For users with complex goals, the server selectively expands detail only for those sections of the guidance that are technically significant, such as licensing requirements or safety-related steps.

The system is not merely automating a human planning task; it implements a specific, non-conventional data processing architecture that leverages deep neural network capabilities in conjunction with structured prompt generation and structured output transformation. A human planner would not typically transform natural language descriptions into token sequences, apply semantic role labeling, construct machine-readable structured objects, automatically synthesize prompt sentences encoded with explicit section labels, and subsequently parse and re-structure model outputs into hierarchical data objects optimized for network transmission and device rendering. The server, by executing these non-human, algorithmic steps, achieves technical improvements in data handling, machine learning inference control, and client-server communication.

In alternative embodiments, the server uses different types of generative AI models and natural language processing modules. In one variant, the server uses an encoder-decoder model with attention mechanisms instead of a decoder-only model. In another variant, the server uses a hybrid framework in which a smaller, locally hosted model performs initial semantic analysis and emotion estimation, and a larger, remote generative AI model performs detailed plan generation. The server can also vary the error function used during pre-training of the generative AI model, such as using a masked language modeling objective or a sequence-to-sequence objective, to optimize the model for specific types of guidance generation.

In further embodiments, the server uses different feature sets and models for emotional state recognition. The server may use recurrent neural networks, convolutional neural networks applied to token sequences, or transformer-based classifiers trained on labeled emotional text datasets. The server can apply multi-task learning, where a single model is jointly trained to predict emotional state and content domain, improving classification performance and reducing the number of model calls during inference.

In yet other embodiments, the server uses alternative rule sets for constructing prompt sentences. The server may include a rule engine that supports priority ordering, rule chaining, and context-specific overrides. For example, when the user's goal involves regulatory compliance or safety-critical activities, the server applies rules that mandate explicit requests in the prompt sentence for disclaimers, safety checks, and references to authoritative guidelines. When the user's time information indicates highly fragmented availability, the server applies rules that emphasize micro-tasks and short-duration actions in the prompt sentence.

The terminal, in certain embodiments, performs additional local processing of the structured data to adapt the visual presentation to device-specific constraints, such as small display size, limited processing power, or limited network connectivity. The terminal can cache structured data locally, update only differential parts when the server sends incremental updates, and adjust refresh rates to reduce power consumption. By using structured data rather than unstructured text, the terminal can perform such optimizations efficiently, which contributes to lower communication load and improved responsiveness.

Through these configurations and variations, the system provides a concrete, technical implementation that improves the functioning of computer systems for processing natural language guidance, constructing prompt sentences for generative AI models, and delivering structured outputs to terminals. The server and the terminal cooperate to achieve improvements in speed, accuracy, resource usage, and data management that are not attainable by simple manual planning or by conventional rule-based scheduling tools.

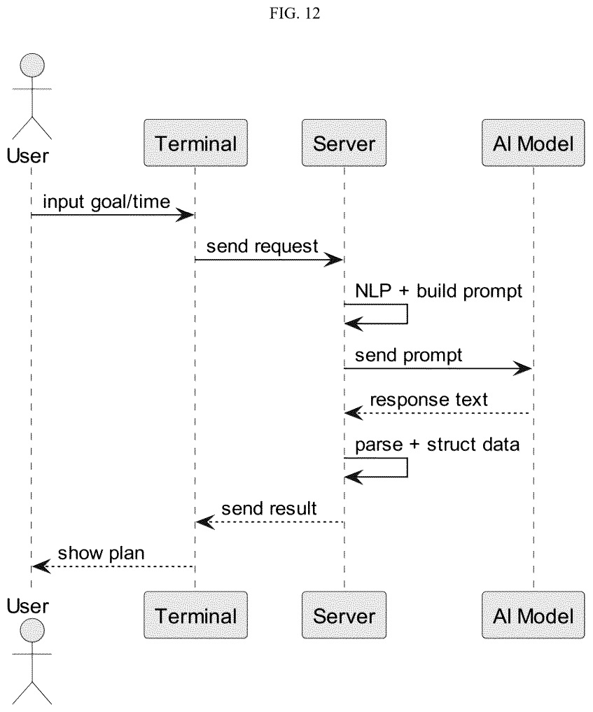

The following describes the processing flow using FIG. 12.

### Step 1:

The user operates the terminal to input goal information and time information.

The user enters natural language text, such as a goal (“I want to become a pilot”) and available time (“I can study 2 hours on weekdays and 4 hours on weekends”), into input fields displayed on the terminal.

The input of this step is raw user keystrokes or touch events, and the output is a text string stored in the terminal's memory. The terminal converts individual key events into a continuous character sequence and stores the resulting text as UTF-8 encoded data.

### Step 2:

The terminal generates a structured request object from the user input.

The terminal reads the text string from the input fields and constructs an internal data object including fields such as goal_text, time_text, user_id, and timestamp.

The input of this step is the raw text string from Step 1, and the output is a structured data object held in RAM. The terminal performs data assembly and simple validation (for example, checking that minimum length requirements are met) to produce a consistent, machine-readable request.

### Step 3:

The terminal transmits the structured request to the server via the network.

The terminal serializes the structured data object into a message format, encapsulates the serialized data in a network request, and sends the request to a predefined server endpoint over a secure transport protocol.

The input of this step is the structured data object generated in Step 2, and the output is a network packet stream containing the serialized request. The terminal performs header generation, encryption, and packetization to convert the in-memory data object into transmittable network data.

### Step 4:

The server receives and parses the structured request from the terminal.

The server accepts the network packets, reconstructs the message, and extracts the serialized data. The server then deserializes the message to restore the structured data object representing goal_text, time_text, user_id, and timestamp.

The input of this step is the network packet stream from Step 3, and the output is a reconstructed structured data object in the server memory. The server performs decryption, integrity checks, and deserialization to convert the network-level representation back into an internal data structure.

### Step 5:

The server performs basic validation and logging of the received data.

The server checks that goal_text and time_text are present and within allowed size limits, and verifies that the content type and format are correct. The server stores a log entry including user_id, timestamp, and excerpts of goal_text for monitoring and debugging.

The input of this step is the structured data object from Step 4, and the output is a validated data object plus a log record persisted in a storage system. The server executes conditional checks and writes the log record into a persistent log file or database.

### Step 6:

The server executes natural language preprocessing of the goal and time text.

The server applies tokenization, part-of-speech tagging, and sentence segmentation to the goal_text and time_text. The server creates a token sequence and tags each token with linguistic attributes.

The input of this step is the validated text fields from Step 5, and the output is an annotated token list for each text field. The server performs text parsing algorithms that map character sequences to token indices, assign part-of-speech tags, and split sentences using language-specific rules.

### Step 7:

The server performs semantic analysis and entity extraction.

The server analyzes the annotated tokens to identify semantic roles, entities such as professions, durations, days of the week, and activity types, and relationships between them. The server detects, for example, that “pilot” is a target profession and that “2 hours on weekdays and 4 hours on weekends” are recurring time allocations.

The input of this step is the annotated token lists from Step 6, and the output is a structured semantic representation, such as a graph or a dictionary containing main_goal, time_constraints, and current_status. The server applies semantic role labeling and pattern-matching algorithms to transform linguistic annotations into a compact, structured representation.

### Step 8:

The server infers a domain category and planning parameters.

The server classifies the main_goal into a domain category, such as “career development” or “language learning,” and determines parameters such as planning_horizon (for example, 3 months or 12 months) and detail_level based on goal complexity and time_constraints.

The input of this step is the structured semantic representation from Step 7, and the output is an extended data structure containing domain_category and planning parameters. The server performs rule-based classification and threshold-based computations on features like text length, detected entities, and time availability.

### Step 9:

The server optionally estimates the emotional state of the user from the text.

The server extracts numerical features from the goal_text and time_text, such as sentiment scores, token n-gram frequencies, and punctuation statistics, and feeds them into an emotion classification model. The server obtains an emotional state label or a probability distribution over emotional categories.

The input of this step is the original text and semantic features from Steps 6 and 7, and the output is an emotional_state indicator added to the user context. The server executes a trained classifier, performing vector multiplication, activation functions, and normalization to map textual features to emotion scores.

### Step 10:

The server constructs a base prompt sentence using templates.

The server selects a prompt template according to the domain_category and planning parameters and inserts values corresponding to main_goal, time_constraints, and current_status into predefined placeholders. The server creates a coherent narrative that describes the user's situation and explicitly asks for specific output sections.

The input of this step is the structured semantic representation and domain_category from Steps 7 and 8, and the output is an initial prompt sentence as a text string. The server performs string substitution and concatenation operations to build the base prompt sentence.

### Step 11:

The server adjusts the prompt sentence based on the emotional state and detail requirements.

The server modifies the base prompt sentence by altering the requested number of steps, the requested level of detail, and the tone of the instructions. For example, the server may add phrases requesting “concise” steps for a stressed user or “more detailed explanations” for a confident user.

The input of this step is the base prompt sentence from Step 10 and the emotional_state indicator from Step 9, and the output is a finalized prompt sentence. The server executes conditional logic that inserts, removes, or rewrites specific segments of the base prompt sentence to match emotional and planning parameters.

### Step 12:

The server tokenizes the prompt sentence and prepares a request for the generative AI model.

The server converts the prompt sentence into a sequence of tokens according to the vocabulary of the generative AI model, and constructs a model input object including the token sequence and generation parameters such as maximum length and temperature.

The input of this step is the finalized prompt sentence from Step 11, and the output is a model-specific input structure ready for inference. The server runs a tokenization algorithm that maps characters to token identifiers and assembles these identifiers into the input format expected by the generative AI model.

### Step 13:

The server transmits the model input to the generative AI model and requests generation.

The server sends the model input object to a remote inference service that hosts the generative AI model. The server includes the prompt token sequence and generation parameters in an API request over the network.

The input of this step is the model input structure from Step 12, and the output is a request message delivered to the inference service. The server performs serialization into a protocol format and initiates network communication to transfer the request.

### Step 14:

The server receives and decodes the response text from the generative AI model.

The server obtains a response message from the inference service containing a sequence of output tokens. The server decodes the token sequence into a text string representing the generated guidance.

The input of this step is the response message from the inference service, and the output is response text in the server memory. The server reverses the tokenization mapping, concatenates the decoded tokens into sentences, and normalizes whitespace and punctuation.

### Step 15:

The server segments the response text into logical sections and items.

The server analyzes the response text to detect section headers, numbered steps, and schedule descriptions. The server splits the text into components such as overview, list of steps, required skills, and weekly schedule.

The input of this step is the response text from Step 14, and the output is a set of text segments mapped to semantic labels. The server applies pattern matching, regular expressions, and simple parsing rules to segment the text and assign each segment to a category.

### Step 16:

The server converts the segmented response into structured data with item and time allocation information.

The server creates a data structure that records each step as an item with attributes such as title, description, and associated time range. The server parses schedule descriptions to extract quantitative time allocation information, such as hours per week or specific day assignments.

The input of this step is the set of text segments from Step 15, and the output is structured data containing item information and time allocation information. The server performs string extraction, numeric parsing, and mapping operations to populate fields in the structured data.

### Step 17:

The server formats the structured data for transmission to the terminal.

The server serializes the structured data into a transmission-friendly representation, adds metadata such as generation time and model identifier, and encapsulates the result in a network response format.

The input of this step is the structured data from Step 16, and the output is a serialized response message. The server executes serialization routines and constructs a response object that is ready to be sent over the network.

### Step 18:

The server sends the formatted response to the terminal.

The server transmits the serialized response message via the network using a reliable transport protocol, directing it to the terminal that issued the original request.

The input of this step is the serialized response message from Step 17, and the output is a stream of network packets containing the response data. The server performs packetization and sends the packets through its network interface.

### Step 19:

The terminal receives and decodes the structured response data.

The terminal reconstructs the response message from the network packets and then deserializes the message to restore the structured data including item information and time allocation information.

The input of this step is the network packet stream from Step 18, and the output is a structured data object in the terminal's memory. The terminal performs network reassembly, integrity checks, and deserialization to transform the packets into usable application data.

### Step 20:

The terminal updates its internal state and prepares visual elements.

The terminal maps the structured data fields to internal view models or state variables and determines suitable user interface components for each item and schedule entry. The terminal organizes steps into lists and maps time allocations to calendar or timeline views.

The input of this step is the structured data object from Step 19, and the output is a set of configured UI elements ready for rendering. The terminal performs data binding, layout computation, and view configuration operations to construct the visual structure of the guidance.

### Step 21:

The terminal renders the guidance and schedule information to the display.

The terminal uses its rendering engine to draw text, lists, headings, and graphical indicators of time allocation on the display. The terminal allows the user to scroll through steps, tap to expand details, and view time allocations aligned with days or weeks.

The input of this step is the configured UI elements from Step 20, and the output is a visual representation of the guidance and schedule on the display. The terminal executes graphical rendering algorithms and event registration so that the user can interact with the presented content.

### Step 22:

The user reviews the generated guidance and optionally modifies the input conditions.

The user reads the visualized steps and schedule, evaluates whether the plan fits personal circumstances, and may adjust the goal information or time information using the input fields on the terminal.

The input of this step is the displayed guidance from Step 21, and the output is new or revised natural language text entered by the user. The user processes the information cognitively and initiates new input operations, which can be fed back into Step 1 to start another iteration of the processing flow.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional goal-support and time-management systems, computer processing is typically limited to simple scheduling operations, such as registering events in a calendar or setting reminders at specific times. Such systems generally require a user to manually decompose a long-term objective into concrete steps and to translate those steps into time slots, imposing a heavy cognitive burden on the user. Although natural language processing techniques and generative AI models have recently been used to generate general advice, known systems often treat the generative AI model as a black box that merely returns unstructured text, without providing any specialized mechanisms for: (i) constructing prompt sentences that incorporate user context in a systematic and reusable way, (ii) converting free-form model output into structured, machine-usable step sequences and time allocations, and (iii) iteratively refining those structures through interaction while maintaining consistency with user constraints such as available time, target deadlines, and resource limitations. As a result, existing computer systems exhibit several technical limitations. First, input handling is not optimized for continuous, iterative natural language interaction, so the system cannot efficiently transform successive user utterances into a coherent, updatable internal representation of goals and schedules. Second, response handling does not exploit the structural information implied in the generative AI model's output, leading to inefficient storage, poor retrieval, and limited ability to algorithmically adjust sequences of recommended actions. Third, adaptation to a user's emotional state or motivational state is often performed, if at all, at the display layer as mere cosmetic messaging, rather than at the level of the underlying data structures that drive time allocation and step-by-step guidance. Consequently, computer resources are not effectively used to generate and maintain personalized, dynamically adjustable guidance plans, and system behavior is not robust when user conditions or constraints change over time.

Accordingly, there is a need for an improved computer-implemented system that uses a processor and a generative AI model not only to generate text, but to (i) systematically construct prompt sentences embedding user context and system instructions, (ii) transform the model's response into structured data representing action steps, time allocation, and daily schedules, and (iii) iteratively regenerate and adjust these structures in response to follow-up natural language input and inferred user states. Such a system should improve the functioning of the computer by providing specialized data processing pipelines for prompt construction, response structuring, and dynamic reconfiguration of guidance, thereby enabling more efficient computation, better reuse of context, and more accurate alignment between generated recommendations and computed user constraints.

The specific processing by the specific processing unit 290 of the data processing device 12 in Example 2 is realized by the following means.

The present invention provides a server comprising a processor configured to acquire, via an information processing terminal, natural language input information regarding a current situation and an objective of a user and to generate structured text data based on the input information; to generate, based on the structured text data, a prompt sentence for input to a generative AI model, the prompt sentence including a system instruction, user history information, and the input information, and to transmit the prompt sentence to the generative AI model; to analyze response text obtained from the generative AI model and to perform data processing on the response text to generate proposal information including a plurality of action steps for achievement of the objective of the user, time allocation corresponding to the action steps, and a daily schedule plan; to convert the proposal information into structured data in which a list of the action steps, time management proposals, and schedule candidates are hierarchically organized or listed, and to edit the structured data into a format transmittable to the information processing terminal; to provide, via the information processing terminal, an interactive interface that presents the proposal information visually or audibly, accepts follow-up natural language input from the user, and iteratively updates the prompt sentence and the proposal information based on the follow-up natural language input; to estimate an emotional state or a motivational state of the user based on at least the structured text data and the response text, and to adjust at least one of a strictness, a load amount, and a concreteness of the time allocation and the daily schedule plan in the proposal information in accordance with an estimation result; and to reconstruct an existing sequence of the action steps based on the response text and follow-up input from the user, and to dynamically regenerate step-by-step guidance for achievement of the objective of the user by updating at least one of an order, a granularity, and a required time of the action steps in accordance with at least one of a target completion time, an available time period, and a resource constraint. This enables the computer system to internally represent user goals, schedules, and constraints as structured, machine-readable data derived from generative AI model interactions, to automatically adjust and regenerate guidance plans in response to changing user conditions and inferred states, and to improve computational efficiency and responsiveness in providing personalized, step-by-step time-management support.

The term “information processing terminal” refers to an electronic device including at least a processor, a memory, an input interface, and a display or audio output interface, and configured to transmit data to and receive data from a server over a communication network.

The term “natural language input information” refers to information expressed in a human language, such as text entered by a user via a keyboard, touch interface, voice recognition system, or other input mechanism, and describing at least a current situation, an objective, or constraints of the user.

The term “structured text data” refers to data generated from natural language input information by applying parsing, segmentation, annotation, or formatting, and represented in a machine-readable format such as key-value pairs, tagged text, or a hierarchical data structure that explicitly identifies elements including user attributes, objectives, constraints, and context.

The term “objective of a user” refers to a desired future state or outcome specified by the user, including but not limited to a career goal, a skill acquisition goal, a health goal, or a lifestyle improvement goal, which the system supports through generation of action steps and time-management guidance.

The term “prompt sentence” refers to a data structure including instructions, examples, and contextual information, formatted for input to a generative AI model, and comprising at least one portion representing system-level directives and at least one portion representing user-specific content such as history information and current input.

The term “generative AI model” refers to a machine-learned model configured to generate text or other content in response to input data, and typically implemented as a neural network trained on large-scale datasets to perform tasks including natural language understanding, text generation, and dialog response generation.

The term “system instruction” refers to a component of a prompt sentence that specifies a role, behavior, style, or constraints for the generative AI model, and that is used to control the type, format, or content of responses generated by the generative AI model.

The term “user history information” refers to data associated with past interactions or stored attributes of the user, including previous inputs, prior objectives, previously generated plans, or learned preferences, which is used to contextualize subsequent processing and prompt construction.

The term “response text” refers to text or text-equivalent data produced by the generative AI model in response to a prompt sentence, and including at least one of explanatory content, recommended actions, time allocations, or schedule suggestions.

The term “proposal information” refers to data obtained by processing the response text and representing, in an explicit structure, recommendations for the user, including a plurality of action steps, corresponding time allocation, and at least one daily schedule plan.

The term “action steps” refers to discrete, executable units of behavior or tasks that contribute toward achievement of an objective of the user, and that may be ordered, grouped, or assigned estimated durations.

The term “time allocation” refers to information indicating an amount of time, time intervals, or frequency assigned to one or more action steps, including but not limited to daily, weekly, or monthly time blocks suggested for execution of those steps.

The term “daily schedule plan” refers to a proposed arrangement of action steps and other activities within one or more days, expressed as time slots, sequences, or patterns that specify when particular steps are to be performed.

The term “time management proposals” refers to recommended ways of distributing available time among different activities or action steps, including constraints, priorities, and balancing between work, rest, and goal-related tasks.

The term “schedule candidates” refers to one or more alternative daily or periodic arrangements of time allocations and action steps, from which the user or the system may select or further refine a particular schedule.

The term “structured data” refers to data organized according to a predefined schema, such as nested lists, trees, tables, or objects, enabling programmatic access to specific elements including action steps, time allocations, and schedule elements.

The term “interactive interface” refers to a user interface implemented on the information processing terminal that supports bidirectional communication with the server, allows the user to input natural language information, and presents updated proposal information in response to user actions.

The term “follow-up natural language input” refers to natural language input information provided by the user after an initial interaction, including modifications, additional constraints, questions, or feedback, which is used to refine or update previously generated proposal information.

The term “emotional state” refers to an inferred condition of the user relating to affective aspects such as stress, anxiety, confidence, or satisfaction, derived from analysis of user input and model responses.

The term “motivational state” refers to an inferred level or type of motivation of the user, such as high motivation, low motivation, or ambivalence, which may influence the aggressiveness, difficulty, or density of recommended action steps.

The term “strictness of the time allocation and the daily schedule plan” refers to a degree to which recommended time allocations and schedules are rigid, closely packed, or precisely specified, as opposed to flexible or loosely defined.

The term “load amount” refers to an estimated burden placed on the user by the recommended action steps and time allocations, including at least the total time required, intensity of tasks, and frequency of activities.

The term “concreteness” refers to a level of specificity and detail in the description of action steps, time allocations, and schedules, such that higher concreteness corresponds to more explicit instructions, examples, or parameter values.

The term “existing sequence of the action steps” refers to an ordered set of action steps previously generated, stored, or presented to the user for achieving the objective.

The term “reconstruct” refers to computationally modifying an existing sequence of the action steps by changing at least one of an order, grouping, duration, or level of detail of the steps, based on new input or constraints.

The term “granularity of the action steps” refers to a level of decomposition of a task into sub-tasks, where finer granularity corresponds to smaller, more detailed steps and coarser granularity corresponds to larger, more abstract steps.

The term “required time of the action steps” refers to an estimated duration or time cost associated with executing a particular action step, which may be represented as a single value, a range, or a probability distribution.

The term “target completion time” refers to a desired point in time or deadline by which the user aims to achieve the objective or complete a set of action steps.

The term “available time period” refers to a time range or collection of time slots during which the user is considered free or able to perform action steps, taking into account work, rest, and other commitments.

The term “resource constraint” refers to a limitation on one or more resources relevant to the execution of action steps, including time, financial resources, physical access, tools, or external services.

In the following embodiments, a server, a terminal, and a user cooperate to implement the claimed system. The server executes one or more computer programs stored in a non-transitory machine-readable medium, and the terminal executes a client-side program or web browser script. The embodiments described below are illustrative and do not limit the scope of the claims.

The server uses general-purpose computing hardware, such as an information processing apparatus including a central processing unit (CPU), a graphics processing unit (GPU) or tensor processing unit (TPU), a main memory, a non-volatile storage device, and a network interface. For example, the server operates on a virtual machine instance or container in a cloud computing environment running a UNIX-like operating system. The server executes an application framework, such as a web application framework implemented in a programming language (for example, a Python framework or a JavaScript runtime environment). The server communicates with a generative AI model execution environment, which may be implemented as a remote inference service or as an on-premise model deployment that uses a neural network architecture.

The terminal uses user equipment hardware such as a smartphone, tablet, or personal computer including a processor, a memory, an input device (touch panel, keyboard, microphone), and an output device (display, speaker, vibration module). For example, the terminal operates on a mobile operating system or desktop operating system and executes a native application or a browser-based application. The terminal communicates with the server via a communication network such as the Internet using secure transport protocols.

The user operates the terminal to supply natural language input information. The user enters text using a software keyboard or provides speech that the terminal converts into text with a speech recognition module. The user describes a current situation, an objective, and constraints such as available time, location, or resources. For instance, the user may input one of the following prompt sentences:
“I am 22 years old and a university student. I want to become a commercial pilot. Please tell me the concrete steps and how to manage my time.”
“I work from 9am to 7pm on weekdays and often feel tired. Please teach me a time management method that allows me to walk for 30 minutes every morning.”
“I want to pass a professional exam in two years while working full-time. Please propose a weekly schedule and step-by-step guidance.”

The terminal sends the textual representation of the user's natural language input, along with metadata such as timestamps and device identifiers, to the server using a structured request format. The terminal may compress the data or batch multiple user inputs before transmission to reduce communication overhead, which contributes to lowering network load and improving responsiveness.

The server receives the user input and performs data processing to generate structured text data. The server applies tokenization, sentence segmentation, and entity recognition using a natural language processing library or an in-house module. The server converts the input into a key-value data structure that explicitly represents user profile attributes (age, occupation), objectives (“become a pilot”), temporal constraints (“only weekends available”), and any deadlines (“within two years”). The server stores this structured text data in a persistent storage system, such as a relational database or a document database, using normalized schemas that allow efficient retrieval and updating. This structuring of data enables the server to reuse context across multiple interactions without re-parsing the entire history each time, reducing computational load and improving throughput.

The server constructs a prompt sentence for input to the generative AI model by combining system instructions, user history information, and current structured text data. The server maintains a prompt template repository that contains predefined system instructions specifying model behavior (for example, “act as a step-by-step planning assistant with explicit time allocations” or “prioritize low cognitive load for users with low motivation”). The server selects an appropriate template based on user attributes and current objectives, and then programmatically fills variable sections of the template with user-specific content. For example, the server may generate a prompt sentence such as:
“You are an assistant that creates concrete, step-by-step plans and time-management strategies.

User profile: 22 years old, university student.

User objective: become a pilot.

User constraints: limited budget, classes on weekdays.

Please output: (1) a numbered list of steps from current status to the objective, (2) recommended time allocation per week, and (3) a sample weekly schedule.”

or
“You are an assistant that designs daily routines with a focus on health habits.

User profile: office worker, working 9am-7pm on weekdays.

User objective: walk for 30 minutes every morning without reducing sleep time.

User constraints: commute time 1 hour, family responsibilities in the evening.

Please propose a practical daily schedule and concrete habit-formation steps.”

By generating prompt sentences in a systematic and parameterized manner, the server improves consistency of model behavior and reduces prompt engineering overhead for each interaction. The server thereby enhances computational efficiency, since the same prompt construction pipeline can adapt to a large variety of objectives with minimal manual adjustment.

The server interacts with a generative AI model implemented as a neural network. The generative AI model can be a transformer-based model with multiple self-attention layers, feed-forward layers, layer normalization, and learned token embeddings. The server accesses the model through an inference API or directly through a model runtime framework. The model is trained on large-scale text corpora using autoregressive language modeling objectives or masked language modeling objectives. During training, the model minimizes an error function such as a cross-entropy loss between predicted tokens and ground-truth tokens. The training process updates model parameters (weights and biases) using an optimization algorithm, for example, stochastic gradient descent with adaptive moment estimation. The model may use data augmentation techniques such as random masking or synonym replacement to increase robustness.

During inference, the server supplies the prompt sentence as a sequence of tokens and obtains probability distributions over next tokens from the model's output layers. The server controls generation with parameters such as sampling temperature, top-k or nucleus sampling, and maximum token length. By adjusting these parameters based on context (for example, lower temperature and shorter max length for strict schedules, higher temperature for exploratory suggestions), the server influences text diversity and determinism to match user needs and system policies.

The server does not rely on the generative AI model as an opaque text source; rather, the server imposes explicit structural constraints on model output. For instance, the server may instruct the model in the prompt sentence to output sections with headers such as “Step 1”, “Step 2”, and “Time Management Plan”. The server then parses the response text by detecting these markers and mapping them into internal data structures. This parsing pipeline includes custom rules that detect numbering schemes, time expressions, and schedule phrases, as well as fallback heuristics when formatting deviates from expectations. As a result, the server transforms unstructured output text into a structured representation comprising arrays of action steps, with associated attributes such as estimated duration, required resources, and temporal relationships (precedence constraints).

The server further calculates time allocation and daily schedule plans by combining the structured output with user constraints stored in the database. For example, if the user works fixed hours on weekdays, the server executes an internal scheduling algorithm that assigns recommended study blocks or habit routines to feasible time slots. The algorithm may implement a greedy assignment strategy or a constraint-satisfaction approach. The server checks for conflicts with existing commitments and adjusts start times or durations accordingly. This scheduling algorithm runs on structured data rather than raw text, which improves computational efficiency and reduces error rates in schedule generation.

The server estimates an emotional state or motivational state of the user based on the structured text data and the response text. The server uses a classification submodule that applies feature extraction to user utterances and system-generated content. Features may include lexical indicators of stress or enthusiasm, sentiment scores computed by a sentiment analysis model, and behavioral patterns such as frequency of follow-up requests and cancellations. The server maps these features to an emotional state label (for example, “highly motivated”, “anxious”, “discouraged”) by using a trained classifier, such as a smaller neural network or a gradient-boosted decision tree model. This classification is not merely cosmetic; it directly influences control parameters of subsequent processing, such as step granularity and load amount. For instance, if the user is inferred to have a low motivational state, the server reduces the number of steps per day, increases the time buffers between tasks, and increases the concreteness of instructions to lower cognitive effort.

The server reconstructs an existing sequence of action steps when the user provides new constraints or when the system detects that previous schedules are no longer feasible. The server maintains a dependency graph for the action steps, where nodes represent steps and directed edges represent precedence constraints (for example, “enroll in training” must occur before “accumulate flight hours”). When the user introduces a new target completion time or modifies available time periods, the server executes a re-scheduling procedure over this dependency graph. The server updates estimated required time for each node, reorders nodes when dependencies allow alternative sequences, and splits or merges nodes to adjust granularity. This graph-based representation enables efficient recomputation of only affected portions of the plan rather than recomputing the entire schedule from scratch, which improves computation time and scalability as the number of steps grows.

The terminal presents proposal information as a user interface. The terminal renders lists of action steps, timelines, calendars, and textual explanations based on structured data obtained from the server. The terminal can allow the user to interact with each step, such as marking completion, requesting more detail, or adjusting preferred time windows. These operations generate additional structured events that the terminal transmits back to the server. In some embodiments, the terminal pre-renders certain user interface components and caches static resources to reduce screen rendering latency and network usage. The division of labor between the server (heavy data processing and AI model interaction) and the terminal (interaction and rendering) is designed to optimize performance over limited-bandwidth networks.

The user consumes the server-generated guidance in the real world. The user adjusts daily behavior according to the action steps and schedule suggested by the system. For example, in the pilot-training scenario, the user may follow a plan that includes researching training institutions on specific days, preparing language examinations in assigned evening blocks, and attending trial classes on designated weekends. In the morning-walk scenario, the user may adopt a wake-up routine with alarms and preparation steps scheduled by the server to minimize friction. These real-world effects demonstrate that the system is not limited to abstract data manipulation but provides concrete technical utility in managing and controlling how the user organizes time and interacts with digital reminders, notifications, and device-level scheduling systems such as calendar applications and alarm managers.

The server improves computer technology in several ways. First, by converting natural language interactions into structured data representations of goals, constraints, and schedules, the server enables efficient querying, updating, and partial recomputation, which reduces processing time and memory usage compared to naive re-generation of entire plans as free-form text for each interaction. Second, by using a pipeline that programmatically constructs prompt sentences, parses model outputs into structured forms, and drives a graph-based scheduling algorithm, the server decomposes a complex problem into modular computational stages that can be independently optimized, parallelized, or cached. Third, by integrating emotional and motivational state estimation directly into the control flow of schedule generation and step reconstruction, the server creates adaptive algorithms that improve accuracy of recommendation alignment with user capacity and reduce the need for repeated manual corrections, which in turn reduces network traffic and server load.

The server uses non-conventional combinations of rule-based parsing, neural network inference, and graph-based scheduling. For instance, the server combines pattern-matching rules for headings and numbering with statistical models for sentiment and intent detection, then feeds the resulting structures into a scheduling engine that applies custom heuristics for splitting complex steps into smaller substeps when motivation is low. This combination of techniques is not equivalent to simple human task decomposition, because the server operates on high-dimensional representations generated by the generative AI model and the classifier, and because it uses algorithmic criteria (for example, bounding daily load amounts, enforcing precedence constraints, and optimizing for minimal deviation from user-preferred time ranges) that are calculated numerically. As a result, the processing provides technical improvements in accuracy, robustness, and scalability compared to manual planning.

In some embodiments, the server runs multiple generative AI models of different sizes or specializations and selects or combines outputs based on the structured context. For example, the server may use a larger model for initial plan generation and a smaller, faster model for incremental adjustments. The server may also precompute generic step templates for common objectives and then adapt these templates to a specific user by parameter substitution and constraint solving. Such precomputation and reuse reduce inference time and network calls to the model runtime, which improves overall system throughput.

In alternative embodiments, the server deploys the generative AI model locally rather than via an external inference service. In such configurations, the server loads model parameters into GPU memory, performs tokenization and detokenization using in-house libraries, and manages memory layouts to avoid redundant allocation during repeated inference calls. The server also adjusts mini-batch sizes and sequence lengths depending on current server load, thereby implementing dynamic resource management for the neural network inference pipeline. These embodiments further highlight that the invention involves concrete improvements in how a computer system runs complex AI models and manages resources.

In another embodiment, the terminal includes a local cache of partial model outputs or intermediate structured data to support offline use cases. The terminal can store previously generated action steps and schedule fragments and allow the user to perform limited rearrangement or annotation without immediate server access. When connectivity is restored, the terminal transmits the delta (difference) between the local state and the last known server state. The server then reconciles the changes by merging and resolving conflicts based on version identifiers and timestamps. This differential update mechanism reduces communication load and allows efficient synchronization for users with intermittent network access.

In yet another embodiment, the server integrates with external device control systems, such as calendar services, alarm managers, or smart home devices. The server translates action steps and time allocations into concrete control commands that create calendar events, set alarms, or adjust smart lighting or audio notifications to support habit formation. The server sends these control commands through appropriate APIs, ensuring that the plan generated at the abstract level is instantiated as tangible device-level behavior. This integration demonstrates a direct link between the generative AI-based plan generation and machine-level control of real-world devices, reinforcing that the system goes beyond abstract information processing.

Overall, the described embodiments allow a person skilled in the art to implement the invention by configuring a server, a terminal, and associated software modules so that the server performs structured context modeling, prompt sentence construction, generative AI model control, structured response parsing, emotional/motivational state estimation, and graph-based schedule reconstruction, while the terminal handles user interaction and local rendering. By designing these modules and data flows in the manner described, the system achieves technical effects such as improved processing speed, increased accuracy of schedule alignment with constraints, reduced communication overhead, and enhanced robustness against changing user states, thereby improving the functioning of the computer system as a whole.

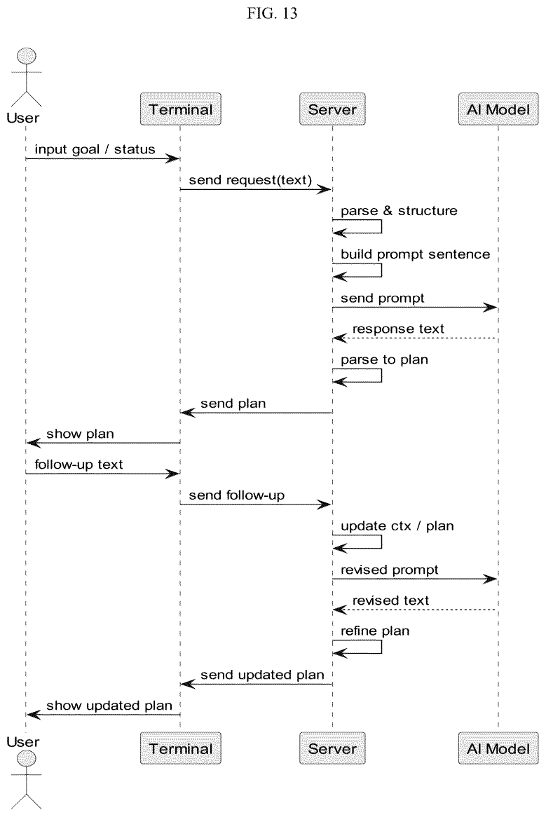

The following describes the processing flow using FIG. 13.

### Step 1:

The user operates the terminal to input natural language information describing a current situation, an objective, and optional constraints.

The terminal receives keystrokes or speech signals as input and converts them into a Unicode text string. The terminal may add metadata such as a user identifier, device type, and a timestamp. The terminal outputs a request payload including the natural language text and the metadata.

### Step 2:

The terminal transmits the request payload to the server over a communication network.

The terminal takes the request payload as input, serializes it into a structured format such as JSON, and sends it via an HTTPS POST request using a network library. The terminal outputs an encrypted network packet sequence directed to the server endpoint.

### Step 3:

The server receives and validates the request payload from the terminal.

The server takes the network packet sequence as input, decodes the HTTPS communication, and parses the JSON body to extract the user text and metadata. The server performs validation checks (for example, length limits, character encoding, required fields) and logs the raw request. The server outputs validated natural language text and associated metadata as internal data objects.

### Step 4:

The server converts the validated natural language text into structured text data.

The server takes the natural language text as input and performs tokenization, sentence segmentation, and entity recognition using a natural language processing library. The server identifies elements such as user profile attributes, objectives, deadlines, and time constraints. The server organizes these elements into a key-value structure or hierarchical object (for example, “profile”, “goal”, “constraints”). The server outputs structured text data representing the user's state and objective.

### Step 5:

The server stores and updates user context in a persistent storage system.

The server takes the structured text data and metadata as input, checks an existing record for the user identifier in a database, and either creates a new record or updates an existing record. The server merges the new structured data with prior user history, such as past goals or previous plans. The server outputs an updated context object that includes both current and historical information.

### Step 6:

The server generates a prompt sentence for a generative AI model using the context object.

The server takes the updated context object as input and selects a system instruction template appropriate for the type of objective (for example, career planning, habit formation). The server fills placeholders in the template with user profile data, objective descriptions, and constraints. The server concatenates system instructions, user history summaries, and current input into a single prompt sentence. The server outputs a complete prompt sentence text ready for model inference.

### Step 7:

The server sends the prompt sentence to the generative AI model and controls model inference.

The server takes the prompt sentence as input, converts the text into tokens using a tokenizer compatible with the neural network model, and sets inference parameters such as temperature and maximum output length. The server calls a model runtime or a remote inference API, providing the tokenized prompt and parameter settings. The generative AI model processes the token sequence through multiple transformer layers and returns a sequence of output tokens. The server decodes these tokens back into response text. The server outputs response text generated by the generative AI model.

### Step 8:

The server parses the response text into structured proposal information.

The server takes the response text as input and applies pattern-based parsing and heuristic rules to detect sections such as numbered steps, headings, and time-management recommendations. The server identifies phrases that indicate action steps, durations, time windows, and schedules. The server maps these elements into a structured representation, such as an array of step objects and a set of schedule objects with fields for start time, duration, and description. The server outputs proposal information containing structured action steps, time allocations, and daily schedule plans.

### Step 9:

The server estimates an emotional state or motivational state of the user based on available data.

The server takes the structured text data, response text, and user history as input and computes features such as sentiment scores, keyword frequencies, and interaction patterns. The server feeds these features into a classifier (for example, a neural network or tree-based model) that outputs a label or score representing the emotional or motivational state. The server uses this label to adjust parameters such as step granularity, workload, and concreteness. The server outputs an adjusted proposal information object that incorporates modifications based on the estimated state.

### Step 10:

The server reconstructs and optimizes the sequence of action steps according to constraints.

The server takes the adjusted proposal information, existing plan data, and constraint data (available time periods, target completion time, resource limits) as input. The server represents action steps as nodes in a dependency graph and applies scheduling algorithms to determine an order and timing that satisfy precedence and constraint conditions. The server may split or merge steps and recalculate required times to balance daily or weekly load. The server outputs an optimized plan containing an ordered list of action steps and an associated schedule that respects user constraints.

### Step 11:

The server formats the optimized plan for transmission to the terminal.

The server takes the optimized plan as input and converts the internal data structures into a response format suitable for the client, such as a JSON object with sections for “goal”, “steps”, and “time_management”. The server adds explanatory text, labels, and identifiers for each step to facilitate display and future updates. The server outputs a serialized response message that encapsulates the proposal information and metadata.

### Step 12:

The server transmits the response message to the terminal.

The server takes the serialized response as input, constructs an HTTPS response with appropriate headers, and sends the response over the network to the terminal's address. The server may compress the payload to reduce bandwidth and record transmission logs. The server outputs network packets carrying the proposal information to the terminal.

### Step 13:

The terminal receives and decodes the response message from the server.

The terminal takes the incoming network packets as input, performs HTTPS decryption, and parses the response body. The terminal extracts the structured proposal information, including action steps, time allocations, and schedule entries. The terminal outputs client-side data structures ready for rendering in the user interface.

### Step 14:

The terminal renders the proposal information and provides interactive controls.

The terminal takes the client-side data structures as input and constructs views such as lists, calendars, and detail panes using its user interface framework. The terminal displays action steps in an ordered list, shows time slots in a calendar view, and presents explanatory text. The terminal also generates interactive elements, such as buttons to mark steps as completed, sliders to adjust preferred time windows, and text fields for follow-up questions. The terminal outputs rendered screens and interactive widgets on the display, and may also output synthesized speech via speakers.

### Step 15:

The user reviews the proposal information and provides follow-up natural language input.

The user takes the displayed plan as input, evaluates whether the steps and schedule are acceptable, and identifies any desired changes or clarifications. The user may interact with controls to adjust constraints or may type a follow-up prompt sentence, such as “I can only study on weekends, please adjust the plan” or “Please make the steps smaller and easier.” The user outputs new natural language text or interaction events through the terminal.

### Step 16:

The terminal packages follow-up input and sends it back to the server for iterative refinement.

The terminal takes the user's follow-up text and interaction events as input, combines them with context identifiers such as the plan ID and version number, and forms an updated request payload. The terminal sends this payload to the server via HTTPS in the same manner as in the initial interaction. The terminal outputs an updated request that triggers another cycle of context updating, prompt sentence generation, model inference, and plan reconstruction by the server.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented guidance systems, such as schedule assistants, recommendation engines, or financial planning tools, typically process user input in a static, rule-based manner. These systems generally treat user goals, schedules, and preferences as fixed parameters and generate plans or recommendations without deeply modeling the user's evolving emotional state, fine-grained behavior history, or multi-domain context including schedules, in-facility routes, and income and expenditure patterns. As a result, the generated guidance is often rigid, poorly aligned with the user's actual capacity, and easily becomes obsolete when the user's emotional state or real-world conditions change.

Furthermore, existing systems that utilize machine learning models or generative AI models are frequently architected as one-shot inference services: an input is converted into a prompt, the model outputs a response, and the response is displayed to the user. Such systems generally lack an integrated processing pipeline that (i) fuses heterogeneous user data (text, audio, image, and numerical data) with external contextual data (schedule data, facility layout data, and income and expenditure history data), (ii) derives structured context data representing a current user state, and (iii) systematically regenerates prompt sentences and re-invokes the generative AI model in a closed loop in response to progress updates and changing emotional states. Without this pipeline, the underlying computer resources—processor, memory, and network interfaces—are used in an inefficient manner, for example by repeatedly providing over-complex plans that the user cannot follow, or by failing to adjust task granularity or execution frequency to maintain user engagement.

In addition, traditional guidance systems often operate independently across domains: a calendar assistant handles time slots, a navigation module handles routes, and a budgeting tool handles expenditures. These components rarely share a unified representation of user state or leverage a single generative AI model orchestrated by task-specific prompt sentences. Consequently, the processor must execute separate, siloed computation paths, which increases complexity and reduces the ability to coordinate time-management plans, in-facility route guidance, and expenditure plans in a consistent, adaptive manner.

There is therefore a need for an improved computer-implemented system that allows a processor to (i) receive and integrate multi-modal user input together with external contextual data, (ii) construct and update structured context data describing user state, (iii) derive task-specific prompt sentences supplied to a generative AI model, and (iv) dynamically adjust and regenerate guidance information—including time-management plans, activity proposals, purchasing behavior plans, route plans, and expenditure plans—in response to user progress input, feedback input, and changing emotional state. Such a system should improve the utilization of computational resources by reducing repeated generation of unsuitable plans, should decrease the need for manual user reconfiguration, and should enable the processor to provide more stable and efficient assistance over time through a closed-loop control of the generative AI model.

The specific processing by the specific processing unit 290 of the data processing device 12 in Application Example 2 is realized by the following means.

The present invention provides a server comprising a processor configured to receive, via an information processing terminal, input representing at least one of a current state, a goal, a schedule, purchase intention data, and income and expenditure data of a user, to receive inquiries from the user, to analyze input text information, audio information, image information, and numerical information using a natural language processing technique and an emotion analysis technique so as to identify an emotional state of the user, goal content, available time, constraint conditions, and behavior history of the user, to generate context data representing a user state on the basis of an analysis result and external information including at least one of schedule information, facility layout information, and income and expenditure history information acquired by an external information acquisition unit, to generate a task-specific prompt sentence on the basis of the context data, to input the prompt sentence into a generative AI model and cause the generative AI model to generate guidance information including at least one of a time-management plan, an activity proposal, a purchasing behavior plan, a route plan, and an expenditure plan as step-by-step guidance, to execute, on the basis of the guidance information output from the generative AI model and the external information, at least one of a schedule registration process for registering events in schedule data, a movement route calculation process for calculating an in-facility movement route, and a budget calculation process for calculating a budget by expenditure category, to generate guidance information including an optimal usage of time and step-by-step guidance toward goal achievement in accordance with a schedule and a goal of the user, to transmit the guidance information to the information processing terminal so that the guidance information is presented to the user by screen display, notification, or audio output, to receive progress input or feedback input from the user, and to regenerate the prompt sentence and execute the generative AI model again on the basis of the progress input or the feedback input and an updated emotional state so as to dynamically update the guidance information. This enables the processor to implement a closed-loop, context-aware control flow over the generative AI model, to adapt guidance content and task granularity in real time in accordance with the user's emotional state and behavior history, and to more efficiently utilize computational resources by coordinating time-management, route calculation, and expenditure planning within a unified, continuously updated guidance system.

The term “processor” refers to a hardware computation unit, or a combination of hardware computation units, configured to execute instructions stored in one or more memory devices so as to perform the functions described in the present specification.

The term “information processing terminal” refers to an electronic apparatus, such as a mobile terminal, a tablet device, a wearable device, or a personal computer, configured to communicate with the server, to acquire user input, and to present guidance information to a user via at least one of a display, a speaker, and a notification mechanism.

The term “current state of a user” refers to information indicating a present situation of the user, including at least one of ongoing activities, available time, physical or mental condition, location context, and environmental constraints at or near the time of input.

The term “goal” refers to a target condition or outcome specified by the user, including at least one of a professional objective, a learning target, a health or lifestyle objective, a financial objective, or a consumption objective.

The term “schedule” refers to structured time-series data describing one or more planned or past events of the user, each event having at least a start time, an end time, and optionally a description, a location, and an associated category.

The term “purchase intention data” refers to information indicating items or services that the user desires to acquire, including at least one of a shopping list, preferred products, or categories of goods or services.

The term “income and expenditure data” refers to numerical or categorical data describing financial inflows and outflows of the user, including at least income amounts, expenditure amounts by category, periodicity of payments, and target savings amounts.

The term “inquiry from the user” refers to a request, question, or command input by the user via the information processing terminal, expressed in text, voice, or other input modality, and addressed to the server for obtaining guidance information.

The term “text information” refers to character-based data obtained directly from user input or derived by transcription of audio data, including natural-language sentences, keywords, numerical strings, and symbolic expressions.

The term “audio information” refers to time-series data representing sound captured by an audio sensor of the information processing terminal, including speech of the user and optionally ambient sound relevant to context or emotion estimation.

The term “image information” refers to visual data captured by an imaging sensor of the information processing terminal, including still images or video frames depicting at least a face or body of the user or a surrounding environment.

The term “numerical information” refers to data represented as values on a numerical scale, including at least time durations, quantities, monetary values, counts, and statistical indicators, whether directly input by the user or derived by computation.

The term “natural language processing technique” refers to a computational method or set of methods executed by the processor to analyze, interpret, or transform natural-language text, including at least tokenization, parsing, entity extraction, intent classification, and semantic interpretation.

The term “emotion analysis technique” refers to a computational method or set of methods executed by the processor to estimate an emotional state of the user using one or more of text information, audio information, and image information, including at least sentiment analysis, prosody analysis, and facial expression analysis.

The term “emotional state of the user” refers to a condition of the user characterized by at least one affective attribute, such as stress level, anxiety, joy, motivation, fatigue, or discouragement, and represented as a discrete label, a continuous score, or a combination thereof.

The term “goal content” refers to structured data representing the semantic meaning of a user's goal, including a goal type, a target level, a desired time frame, and optional constraints or preferences associated with the goal.

The term “available time” refers to one or more time intervals or time amounts in which the user is free to perform additional activities, as determined from the schedule and user-provided constraints.

The term “constraint conditions” refers to limitations or requirements that restrict possible activities or plans for the user, including at least time constraints, location constraints, resource constraints, and personal preference constraints.

The term “behavior history” refers to recorded data describing past actions or events associated with the user, including at least completed tasks, skipped tasks, rescheduled tasks, financial decisions, and shopping behaviors, together with timestamps and outcome indicators.

The term “external information acquisition unit” refers to a functional component, implemented by software, hardware, or a combination thereof, configured to obtain external data from one or more external information sources, such as schedule services, mapping or facility information services, or financial record services.

The term “schedule information” refers to data obtained from an external scheduling service or stored schedule database, indicating past or planned events of the user, and usable for determining available time or registering new events.

The term “facility layout information” refers to structured data describing a physical arrangement of a facility, including at least nodes corresponding to areas or aisles, edges corresponding to walkable paths, and optionally positions of goods, services, or points of interest.

The term “income and expenditure history information” refers to time-series financial data describing past income and expenditure events of the user, including timestamps, categories, and amounts, and optionally metadata indicating payment methods or merchants.

The term “context data representing a user state” refers to structured data generated by the processor that aggregates analysis results and external information into a unified representation of the user's current situation, including at least the emotional state, goals, schedules, constraints, and behavior history.

The term “task-specific prompt sentence” refers to natural-language text generated by the processor on the basis of the context data and tailored to a particular computational task, the text serving as an instruction or query supplied to a generative AI model to obtain guidance information.

The term “generative AI model” refers to a machine-implemented model configured to generate text or other data outputs in response to input text, the model having been trained using machine learning on large datasets and being capable of producing guidance information when supplied with a prompt sentence.

The term “guidance information” refers to data generated by the generative AI model and optionally further processed by the processor, including at least one of a time-management plan, an activity proposal, a purchasing behavior plan, a route plan, and an expenditure plan, and formatted as step-by-step instructions or recommendations.

The term “time-management plan” refers to guidance information specifying allocation of time to activities within a given period, including at least recommended activity types, start times, end times, and frequencies.

The term “activity proposal” refers to guidance information suggesting one or more actions for the user to perform, such as learning tasks, relaxation exercises, or social activities, possibly characterized by difficulty, duration, and priority.

The term “purchasing behavior plan” refers to guidance information related to acquisition of goods or services, including at least suggested items, order of acquisition, and optional timing or location information.

The term “route plan” refers to guidance information describing an ordered sequence of positions or segments defining a movement path for the user within a facility or environment, possibly accompanied by directions or distance estimates.

The term “expenditure plan” refers to guidance information specifying intended spending patterns over a period, including budgets per category, recommended reductions, and target savings levels.

The term “step-by-step guidance” refers to guidance information structured as an ordered set of steps, each step including at least an action description and an execution condition such as time, precondition, or completion of a prior step.

The term “schedule registration process” refers to a computation executed by the processor to create, update, or delete events in schedule data, based on guidance information and existing schedule information.

The term “movement route calculation process” refers to a computation executed by the processor to determine a movement path within a facility on the basis of facility layout information and at least one of a starting position, a destination, and intermediate positions associated with a user's tasks.

The term “budget calculation process” refers to a computation executed by the processor to allocate a total available amount of funds into categories, including at least calculation of recommended spending limits for each category based on income and expenditure history information and an expenditure plan.

The term “optimal usage of time” refers to a recommended allocation of time to activities that satisfies given constraints and goals of the user while taking into account the user's emotional state and behavior history, as determined by the processor.

The term “progress input” refers to information received from the user indicating a status of execution for one or more steps of guidance information, including at least completion, partial completion, non-execution, or rescheduling.

The term “feedback input” refers to information received from the user expressing evaluation or qualitative response to guidance information, including at least difficulty, satisfaction level, perceived stress, or requests for adjustment.

The term “updated emotional state” refers to an emotional state of the user that has been newly estimated by the emotion analysis technique using recent text, audio, or image information, and that may differ from a previously stored emotional state.

The term “change history of the emotional state” refers to a time-series record of emotional states estimated for the user, including at least timestamps and corresponding emotional labels or scores, used to detect trends or variations in emotion.

The term “rest proposal” refers to a component of guidance information recommending non-task periods or low-effort activities intended to reduce stress or fatigue of the user.

The term “activity difficulty level” refers to an attribute attached to an activity proposal that indicates an estimated required effort or complexity for the user, and that can be adjusted by the processor in response to the emotional state.

The term “task division granularity” refers to a degree of subdivision of a task into smaller steps, where finer granularity corresponds to a larger number of smaller, more atomic steps.

The term “execution frequency” refers to a rate or count at which a particular activity or task is recommended to be performed within a time period, such as number of sessions per day or per week.

The term “unexecuted tasks” refers to tasks or steps included in guidance information for which no completion has been reported by the user in the progress input.

The term “short-term goals” refers to goals or sub-goals that are intended to be achieved within a relatively short time frame compared to an overall goal, such as days or weeks, and that are used to maintain motivation and track incremental progress.

In one embodiment, a server implements the claimed system as a network-accessible guidance platform. The server comprises at least one processor, a main memory, a non-volatile storage device, and a network interface. The server executes operating system software, a web framework such as a generic HTTP application framework, and application programs written in a high-level programming language such as a scripting language. The application programs include modules for natural language processing, emotion analysis, generative AI model interaction, external information acquisition, schedule and route computation, and budget computation.

A terminal operates as an information processing terminal. The terminal comprises a processor, a memory, a touch-sensitive display, a microphone, a camera, a speaker, and a wireless or wired communication interface. The terminal executes an application that communicates with the server, collects user input, and presents guidance information by rendering user interface components on the display and by outputting audio via the speaker. The terminal is, for example, a mobile terminal, a wearable device, or a personal computer. A user interacts with the terminal to provide a current state, a goal, a schedule, purchase intention data, or income and expenditure data. The user enters such information as free-form text through a keyboard interface, as structured values through form fields, or as speech captured by the microphone. The user may further allow the terminal to capture image information, including facial expressions, through the camera. The terminal packages the captured text information, audio information, image information and numerical information, together with metadata such as timestamps and device identifiers, and transmits the information to the server via a communication network using a data interchange format such as a structured text format.

The server stores the received information in data structures maintained in the main memory and the non-volatile storage device. In one example, the server stores user goals, schedules, and financial records in relational tables of a local database system such as a lightweight relational database. The server represents user behavior history as records including fields such as goal identifier, task identifier, timestamp, completion status, and user feedback scores. The server represents schedule information as event records including start time, end time, description, and location attributes. The server represents facility layout information as graph-structured data, in which nodes correspond to areas or shelves in a facility and edges correspond to passable paths with associated distances or traversal costs. The server represents income and expenditure history information as time-series records, with amount, category, and time attributes.

The server implements a natural language processing module that transforms user text information and transcribed speech into structured representations. In one embodiment, the server tokenizes the text into word or sub-word units, applies part-of-speech tagging, and identifies named entities corresponding to goals, time expressions, monetary amounts, and activity types. The server then performs intent classification using a trained neural classifier, for example a small recurrent network or transformer-based network, to determine whether the user seeks time-management assistance, route planning, purchasing assistance, or expenditure planning. The server extracts goal content, available time, and constraint conditions from the text using rule-based patterns and learned sequence labeling models.

The server implements an emotion analysis module that combines multiple modalities. For text information, the server applies a sentiment classifier trained on labeled text data. In an embodiment, this classifier is implemented as a two-layer bidirectional recurrent neural network or a transformer encoder with an output layer producing sentiment scores such as positive, negative, and neutral, and also producing an estimated stress level. The model is trained using supervised learning, where the server minimizes a cross-entropy error function between predicted and ground-truth emotion labels by updating model weights with a gradient descent optimization method. For audio information, the server extracts acoustic features such as short-time energy, fundamental frequency contours, Mel-frequency cepstral coefficients, and pitch variability. The server supplies these features to a separate neural model trained to classify emotional prosody into categories such as calm, stressed, or anxious. For image information, the server detects a face region using a classical computer vision algorithm or a convolutional neural network, extracts facial landmarks or feature maps, and applies an emotion recognition model trained on facial expression datasets.

The server fuses the resulting emotion indicators into a unified emotional state representation. In one embodiment, the server normalizes the sentiment scores, prosody scores, and facial expression probabilities into a common range and computes a weighted sum for each emotion dimension, where the weights are predetermined or learned from historical data. The server then selects the dominant emotional state and stores it in association with the current context. This fusion process improves robustness and accuracy compared to any single modality, thereby reducing misclassification errors and enabling more reliable adaptation of guidance information.

The server constructs context data representing a user state by aggregating the identified emotional state, goal content, available time intervals derived from schedule information, constraint conditions, and behavior history. The context data is represented as a structured object including, for example, fields for goal type, remaining time until a goal deadline, recent completion rates, stress trend, and available time blocks. For purchasing guidance, the context data further includes nodes of a facility layout graph that correspond to items in the user's purchase intention data. For expenditure planning, the context data further includes per-category expenditure statistics computed from income and expenditure history information.

The server generates a task-specific prompt sentence on the basis of the context data. The server uses template-based prompt generation logic that incorporates context fields into predefined natural-language patterns. For example, when the user's goal is to become a data scientist and the schedule indicates specific available hours, the server generates a prompt sentence such as:
“User goal: become a data scientist. Current skill level: beginner in programming. Available time: 2 hours per weekday and 4 hours per weekend day. Emotional state: slightly anxious but motivated. Using a step-by-step format, propose a detailed learning roadmap, including required skills, recommended topics, approximate time for each phase, and example projects.”

When the user's goal is to become a pilot, the server generates a prompt sentence such as:
“User goal: become a pilot. User has a full-time job and is available mainly on evenings and weekends. Please propose the steps required to become a pilot, including training options, approximate costs, recommended study schedule, and a realistic timeline. Consider that the user might sometimes feel discouraged.”

When the user expresses anxiety about a presentation, the server generates a prompt sentence such as:
“The user feels stressed and anxious about an upcoming presentation tomorrow. The user has 3 free hours this evening. Propose a short preparation schedule and multiple relaxation techniques (such as breathing exercises, short walks, or music) that can help reduce anxiety. Provide a clear step-by-step plan.”

For purchasing and route planning, the server generates a prompt sentence such as:
“The user's shopping list contains: milk, bread, eggs. The store has sections in the order: entrance, bakery, dairy, eggs, checkout. Suggest an efficient order for visiting sections and explain the route briefly in plain language.”

For savings planning, the server generates a prompt sentence such as:
“User wants to increase savings this month. Income and monthly expenses are as follows: [summarized numbers]. The user feels worried and stressed about money. Propose a realistic small-step savings plan that reduces discretionary spending slightly, avoids overwhelming changes, and includes encouraging messages.”

The server supplies the prompt sentence to a generative AI model. In one embodiment, the generative AI model is a large-scale language model implemented as a multi-layer transformer neural network, in which each layer applies self-attention and feed-forward sublayers to a sequence of token embeddings representing the prompt sentence. The model parameters are obtained through pre-training on a large corpus and optionally fine-tuned on domain-specific data. During inference, the server feeds tokenized prompt sentences into the model, receives token probabilities at each decoding step, and deterministically or stochastically selects tokens according to a sampling strategy such as top-k or nucleus sampling with constrained temperature to control output variability. The server can further constrain the model to output structured formats by adding instructions in the prompt or by post-processing.

The server does not merely replace human reasoning with generic text generation. The server interacts with the generative AI model through non-conventional, context-dependent prompt sentences that encode specific data structures, including time windows, graph positions, and budget categories. The server then post-processes model outputs in algorithmic modules that implement constraint checking, route optimization, and budget balancing. For example, the server parses the generated time-management plan into a list of activities with durations and priorities, and then maps those activities into concrete schedule slots without conflicts. This combined use of neural generation and deterministic constraints produces guidance information that respects real-world limitations and optimizes resource usage, which human users or simple rule systems cannot effectively achieve at comparable scale or speed.

For route planning, the server uses the facility layout information graph. The server selects nodes corresponding to locations of desired items in the purchase intention data and computes an approximate optimal route visiting these nodes. The server may apply a shortest-path algorithm such as Dijkstra's algorithm or a traveling-salesman heuristic using a graph processing library. The server then combines the route nodes with natural-language instructions from the generative AI model, which explains the route in a user-friendly manner. This combination reduces cognitive load for the user while the graph algorithm ensures computationally efficient path finding in the facility.

For schedule registration, the server interacts with a calendar service through an external programming interface. The server generates event objects from the time-management plan and inserts them into schedule information such that start times and end times do not overlap existing events beyond a threshold. The server may also compress or shift events if necessary to maintain continuity and reduce fragmentation of free time. This processing improves the structure of the schedule compared to naive insertion, thereby reducing the number of conflicts and improving practical usability.

For budget calculation, the server analyzes income and expenditure history information using statistical aggregations. The server computes mean and variance of expenditures per category, identifies categories with discretionary spending, and simulates possible reductions while maintaining feasibility based on historical patterns. The server then uses the generative AI model to generate explanations and motivational messages, while the numeric budget constraints are maintained by deterministic algorithms. This separation allows precise financial control combined with user-adapted communication.

The server logs progress input and feedback input from the user. The server updates behavior history and recomputes derived metrics such as completion rates, delay statistics, and emotion trends, stored as rolling averages or exponential moving averages. The server detects patterns such as repeated under-performance or sustained high stress. Based on these patterns, the server modifies future prompt sentences to request simpler plans or to emphasize rest and achievable goals. For example, when the user consistently studies less time than initially planned and reports discouragement, the server generates a prompt sentence such as:
“The user is trying to become a data scientist. The original plan required 2 hours of daily study, but the user can currently manage only 30 minutes and feels discouraged. Propose a revised plan focused on smaller, achievable steps, with clear quick wins and encouragement. Keep total daily effort to about 30-45 minutes.”

In response to such prompt sentences, the generative AI model proposes shorter, re-segmented steps. The server then rewrites schedule events and step lists accordingly. As a result, the server adaptively reduces task division granularity and execution frequency to fit the user's observed capacity and emotional state.

This architecture yields technical effects beyond mere automation of human planning. By representing user context as structured data, and by using this representation to dynamically generate task-specific prompt sentences, the server controls the generative AI model as a computational sub-module rather than as a generic text generator. The server therefore reduces unnecessary calls to the model by rejecting or compressing redundant planning steps and by caching effective plan components. The server can batch multiple low-priority adjustments in a single model invocation, lowering communication and computation overhead. The fusion of multi-modal emotion signals improves the accuracy of user state estimation, which in turn reduces the number of failed or abandoned plans and the need for remedial recomputation, improving overall processing efficiency.

Further, the server's coordinated processing of time-management, route optimization, and budget allocation improves resource utilization at the hardware level. By aligning guidance information across these domains, the server avoids generating conflicting or infeasible recommendations that would otherwise trigger additional user interactions and repeated plan generations. This reduces the number of database operations, external API calls, and model inferences, thereby lowering load on the processor, memory, and network interface. From a technical perspective, the invention improves the functioning of the computer system by implementing a closed-loop control mechanism that continuously refines AI-generated guidance based on quantitative performance metrics and emotion signals, rather than statically executing independent modules.

In alternative embodiments, the server may implement different neural architectures for the generative AI model, such as recurrent networks with attention mechanisms, or may deploy multiple specialized models: a planning model for task decomposition, a style model for emotional tone, and a constraint-aware model for schedule summarization. The server may also use different error functions during training, such as combined cross-entropy and mean-squared error losses for multitask objectives, and may apply data augmentation techniques to training data, such as paraphrasing goals or injecting synthetic noise into schedules, to improve robustness. The server may further adjust hyperparameters such as learning rate, number of layers, and attention heads to trade off inference speed and accuracy.

In other embodiments, the terminal may perform a subset of the analysis locally, such as initial speech recognition or face detection, and transmit intermediate features rather than raw audio or video to the server. This reduces uplink bandwidth and lowers latency. The server may then reconstruct high-level context from those features and proceed with the same context-driven prompt generation and model interaction. In yet another embodiment, the system may be distributed across multiple servers, where one server handles emotion analysis and context construction, and another server handles generative AI model inference, thus balancing computational load and improving scalability.

Through these embodiments, the server, the terminal, and the user cooperate to implement the claimed system. The system uses specific data structures for schedules, facility graphs, and financial records, applies defined neural architectures and training procedures for natural language processing and emotion analysis, and orchestrates a generative AI model using precisely constructed prompt sentences. By integrating these components in a closed-loop architecture that dynamically adapts guidance information to the user's state, the system provides improved processing speed, accuracy of recommendation, reduced error due to misaligned plans, and more efficient management of computing and communication resources compared to conventional systems.

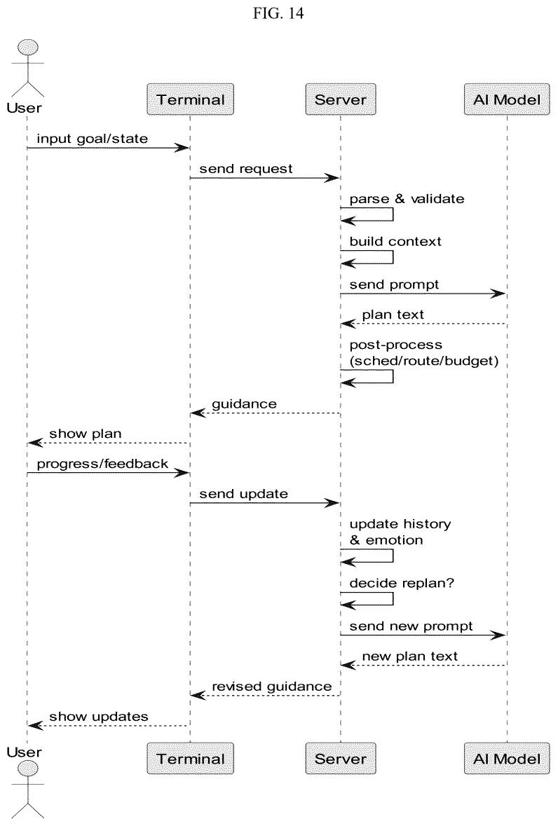

The following describes the processing flow using FIG. 14.

### Step 1:

User operates the terminal to input a current state, a goal, and related data.

User opens an application on the terminal and selects a function such as goal planning, shopping assistance, or savings planning. User types free-form text (for example, “I want to become a data scientist,” “I feel stressed about tomorrow's presentation,” “I want to save more money this month”), fills in structured fields (for example, available daily study time, monthly income and expenses, or a shopping list), and optionally speaks into the microphone or looks at the camera.

Input: raw text strings, form values (numbers, dates, categories), audio stream, image or video frames.

Output: a locally assembled request object containing user text, numeric parameters, and media data.

Terminal collects these elements, attaches metadata such as timestamp, device identifier, and selected mode, and stores them temporarily in memory as a structured request object for transmission.

### Step 2:

Terminal transmits the structured request to the server.

Terminal serializes the request object into a structured text format, including references or encodings for audio and image data. Terminal opens a secure network connection to the server and sends the serialized request to an appropriate endpoint (for example, a goal-planning endpoint or a shopping-route endpoint).

Input: locally assembled request object with user input and metadata.

Output: a network message delivered to the server containing the serialized request.

Terminal waits for an acknowledgment from the server and may display a “processing” indicator to the user while the server is working.

### Step 3:

Server receives and validates the request from the terminal.

Server accepts the incoming network message at a designated endpoint and parses the structured text into an internal data structure. Server checks that required fields (such as user identifier, main text content, and mode) are present and that numeric fields (such as time durations or monetary amounts) fall within acceptable ranges.

Input: serialized request message from the terminal.

Output: validated internal representation of the session, including user input and context flags, or an error status if validation fails.

Server logs basic information (such as request type and timestamp) to a log store and, if validation fails, prepares an error response for the terminal.

### Step 4:

Server stores user input and context data in persistent storage.

Server writes validated user text, numeric parameters, and mode information into database tables for goals, schedules, financial records, and sessions. Server stores large media data (audio, image, video) in file storage or a media repository and records references (such as file paths or identifiers) in the database.

Input: validated internal representation of the request, including text, numbers, and media references.

Output: persistently stored session records and media references, plus in-memory handles to these records for further processing.

Server uses this stored data to maintain user behavior history and to allow later analysis and re-planning.

### Step 5:

Server acquires external contextual information when needed.

Server determines from the mode whether external information, such as schedule data, facility layout data, or financial history data, should be retrieved. Server calls calendar services to obtain event data, accesses a layout repository to load facility graphs, or queries financial tables to retrieve past income and expenses.

Input: session context indicating mode (goal planning, shopping, savings) and identifiers (user identifier, facility identifier).

Output: contextual datasets including event lists, facility graphs, or financial time-series, held as in-memory data structures.

Server converts this external information into standardized forms, such as arrays of events or graph node and edge lists, for downstream processing.

### Step 6:

Server performs natural language processing on user text.

Server tokenizes the user's text, applies part-of-speech tagging, and runs intent classification and entity extraction models. Server identifies goal phrases, time expressions, action verbs, monetary amounts, and constraint phrases (for example, “only evenings,” “limited budget”).

Input: raw user text from the session.

Output: structured text annotations, including detected goal content, time constraints, monetary entities, and an intent label (such as goal-planning intent, route-planning intent, or savings intent).

Server stores these annotations in memory as part of the current session context, enabling later prompt generation.

### Step 7:

Server executes emotion analysis using text, audio, and image data.

Server passes user text to a text-based sentiment classifier to obtain sentiment scores and a preliminary emotional state. Server extracts acoustic features from the audio (such as energy, pitch, and spectral descriptors) and supplies them to an audio-based emotion classifier. Server extracts face regions and facial landmarks from image or video data and applies a face-based emotion classifier to estimate facial expressions.

Input: user text, audio features derived from audio streams, and image features derived from image or video frames.

Output: modality-specific emotion indicators, such as sentiment scores, prosody-based stress scores, and facial emotion probabilities.

Server normalizes and combines these indicators into a unified emotional state vector representing the dominant emotional state and intensity, and associates this vector with the session.

### Step 8:

Server derives a structured user context from all collected data.

Server merges the goal annotations, intent label, detected emotional state, schedule information (including free time slots), facility layout data, and financial history into a single context object. For schedules, server computes available time blocks by subtracting event times from a configurable daily span. For facility layout, server maps each item in the user's shopping list to a node in the facility graph. For finances, server aggregates expenditures by category and computes typical spending levels.

Input: text annotations, emotion state, external datasets (events, graphs, financial records).

Output: a context object containing goal type, extracted constraints, emotion summary, available time blocks, item locations, and expenditure summaries.

Server caches this context object for subsequent prompt construction and numerical computations.

### Step 9:

Server generates a task-specific prompt sentence for the generative AI model.

Server selects a prompt template based on the intent label and fills template slots with values from the context object, such as goal description, available time ranges, emotional state labels, shopping list, or financial summaries. Server formats this filled-in template as coherent natural-language instructions to the generative AI model.

Input: context object containing structured user state and intent.

Output: a task-specific prompt sentence that encodes the user's goal, constraints, and emotional context in natural language.

Server ensures that the prompt sentence clearly requests step-by-step guidance, including the types of plans needed (time-management plan, route plan, expenditure plan, or activity proposal).

### Step 10:

Server requests a plan from the generative AI model using the prompt sentence.

Server sends the prompt sentence to a generative AI model interface, specifying generation parameters such as output length and sampling temperature. Server waits for the model to produce text that proposes step-by-step guidance in response to the prompt.

Input: task-specific prompt sentence and model configuration parameters.

Output: generated guidance text including proposed steps, high-level schedules, recommended activities, route descriptions, or expenditure suggestions.

Server receives the generated text and stores it in memory for further parsing and validation.

### Step 11:

Server parses and structures the generative AI model output.

Server analyzes the generated guidance text to identify individual steps, time allocations, route segments, and budget recommendations. Server uses pattern matching and lightweight parsers to extract structured units (for example, step identifiers, descriptions, estimated durations, category adjustments) from the free-form text.

Input: raw generated guidance text from the generative AI model.

Output: structured guidance data, such as lists of steps with attributes, suggested time blocks, ordered location sequences, and per-category budget changes.

Server checks for basic consistency, such as matching numbers of steps and valid time formats, and discards or corrects obviously inconsistent elements.

### Step 12:

Server computes concrete schedules, routes, and budgets from structured guidance data.

Server maps suggested time blocks to precise time ranges within available schedule slots, resolving conflicts with existing events and adjusting start and end times as necessary. Server uses the facility layout graph to compute efficient movement routes that match the order of item locations, applying shortest-path or route-optimization algorithms. Server calculates revised budgets by applying proposed percentage changes or fixed reductions to historical spending categories, verifying that resulting totals are consistent with income and target savings.

Input: structured guidance data, available time blocks, facility graph, and financial summaries.

Output: finalized concrete plans, including specific calendar events, a step-wise in-facility route, and numeric budget allocations per category.

Server updates the context object with these concrete plans and stores them in the database for tracking and future updates.

### Step 13:

Server composes a response containing guidance information for the terminal.

Server combines structured guidance data and concrete plans into a single response object.

Server creates user-readable text summaries, step lists, calendar event descriptions, route instructions, and budget breakdowns. Server includes identifiers for each step and event so that later progress and feedback can be mapped back to specific elements.

Input: finalized plans and associated metadata (step identifiers, event details, route nodes, budget numbers).

Output: a response object ready for transmission, containing all guidance information in both structured and human-readable forms.

Server serializes this response and sends it back to the terminal over the network.

### Step 14:

Terminal presents the guidance information to the user and records actions on the user interface.

Terminal receives the response from the server and parses the structured data. Terminal displays lists of steps, schedules, route diagrams, and budget information in suitable screens, and may render portions as notifications or audio prompts. Terminal associates interactive controls (such as checkboxes or buttons) with each step and event so that the user can indicate completion, skip, or request changes.

Input: serialized response object with structured guidance information.

Output: rendered user interface elements and interactive controls visible and actionable by the user.

Terminal optionally stores a local copy of key guidance elements for offline viewing or quick updates.

### Step 15:

User executes recommended actions and provides progress input and feedback.

User follows the suggested calendar events, route instructions, and budget recommendations in the real world. User then uses the terminal to mark steps as completed, partially completed, skipped, or postponed. User may also enter comments such as “this was too difficult,” “I need more rest,” or “I could save only half of the suggested amount,” and may provide updated audio or image input showing current emotion.

Input: visual presentation of guidance information and interactive UI elements on the terminal.

Output: user-generated progress and feedback data, including completion flags, comments, and optional new media samples.

Terminal captures this new input and prepares it for transmission back to the server.

### Step 16:

Terminal transmits progress input and feedback to the server.

Terminal aggregates updated step statuses, associated timestamps, user comments, and any new audio or image data into an update request. Terminal serializes this update request and sends it securely to a designated update endpoint on the server.

Input: user progress flags, feedback comments, and optional new media data.

Output: a structured update message delivered to the server for analysis.

Terminal confirms successful transmission and may show the user a brief acknowledgment that the plan will be updated.

### Step 17:

Server logs updates, recomputes emotion, and evaluates plan performance.

Server receives the update request, parses it, and writes progress entries and feedback into behavior history tables. Server applies the same emotion analysis pipeline to any new text, audio, or image data to compute an updated emotional state. Server compares planned versus actual completion times and frequencies, computing statistics such as completion rate and delay per step.

Input: update message with progress data, feedback, and new media samples.

Output: updated behavior history records, updated emotional state, and performance metrics associated with the current plan.

Server determines whether deviations from the original plan or changes in emotional state exceed predefined thresholds that justify re-planning.

### Step 18:

Server generates revised prompt sentences and obtains updated guidance from the generative AI model when re-planning is needed.

Server constructs a new context object that includes performance metrics and updated emotional state. Server selects an appropriate revision template and generates a revised prompt sentence that explicitly describes under-performance, stress, or other issues (for example, a prompt indicating that the user can only study 30 minutes instead of 2 hours and feels discouraged). Server again sends this revised prompt sentence to the generative AI model to obtain adjusted guidance, such as smaller steps, extended timelines, or gentler savings targets.

Input: updated context object including performance metrics and new emotional state.

Output: revised prompt sentence and new generated guidance text from the generative AI model.

Server parses and structures this new guidance, recomputes concrete schedules, routes, or budgets as needed, and prepares another response to the terminal.

### Step 19:

Terminal receives revised guidance and presents adjustments to the user.

Terminal accepts the updated response, parses revised steps and events, and highlights changes relative to the previous plan (for example, reduced daily study time or simplified savings targets). Terminal prompts the user to review and accept the revised plan.

Input: revised guidance response from the server.

Output: updated user interface showing modified steps, rescheduled events, adjusted route or budget, and options to accept or request further changes.

User can then proceed under the adjusted plan, and the overall cycle of input, analysis, planning, execution, feedback, and re-planning continues.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

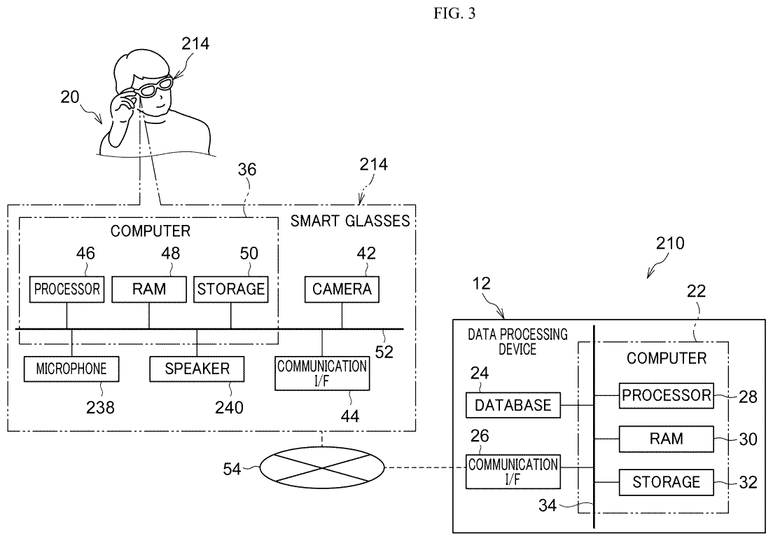

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

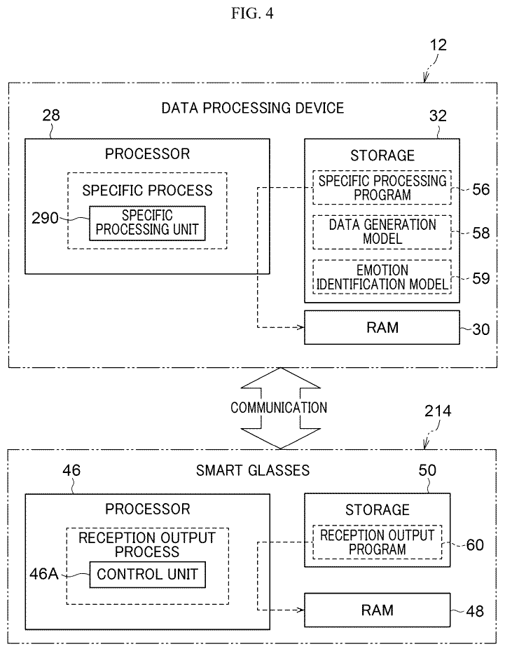

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

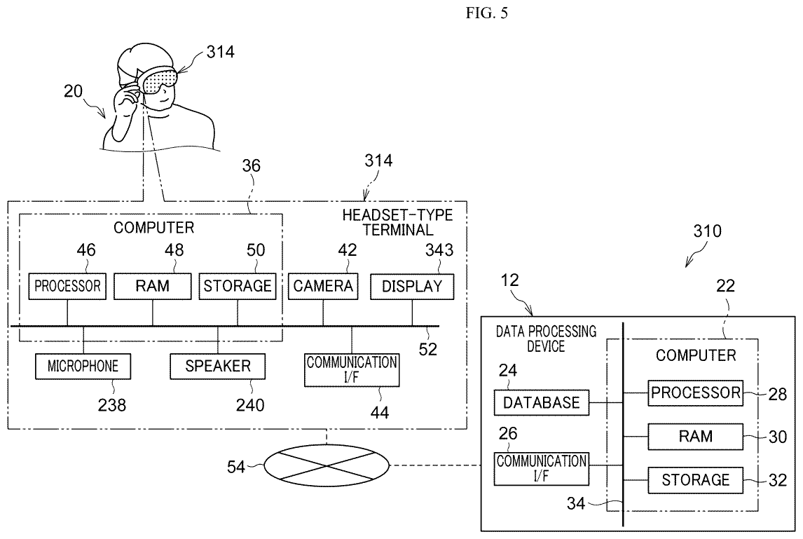

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

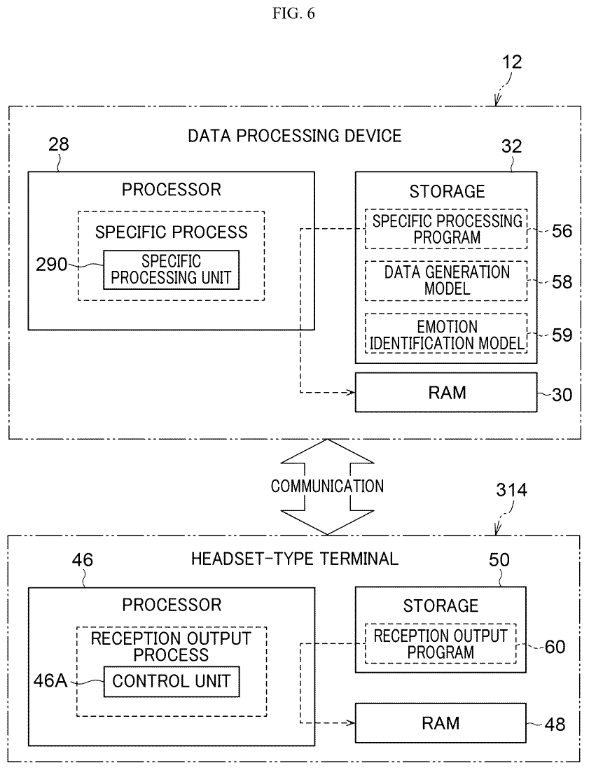

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

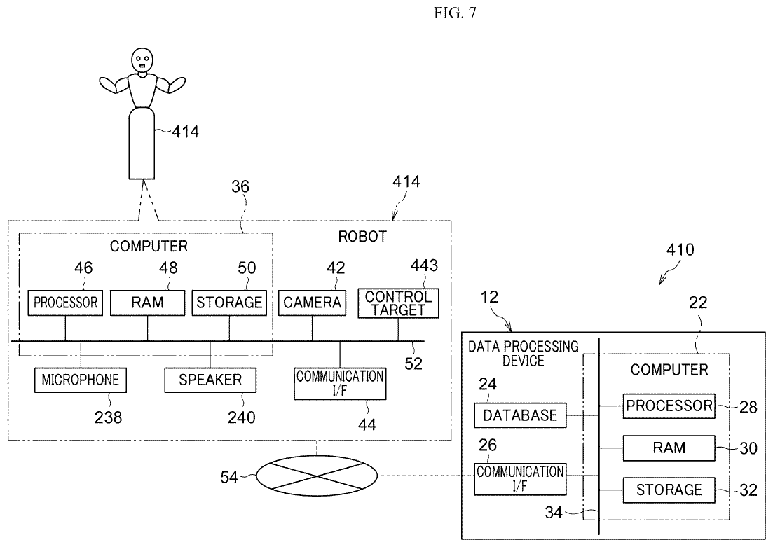

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

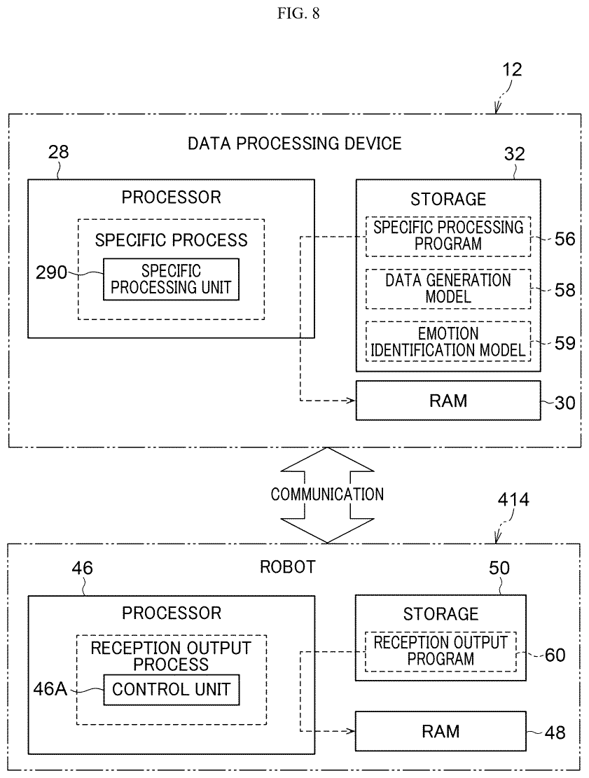

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

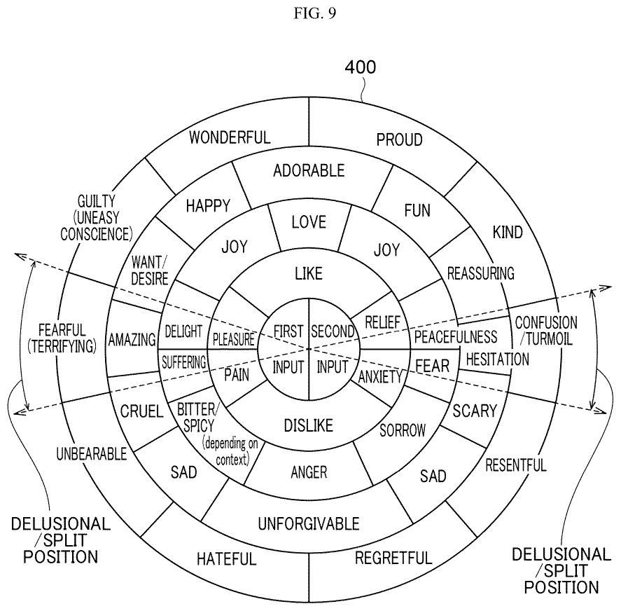

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

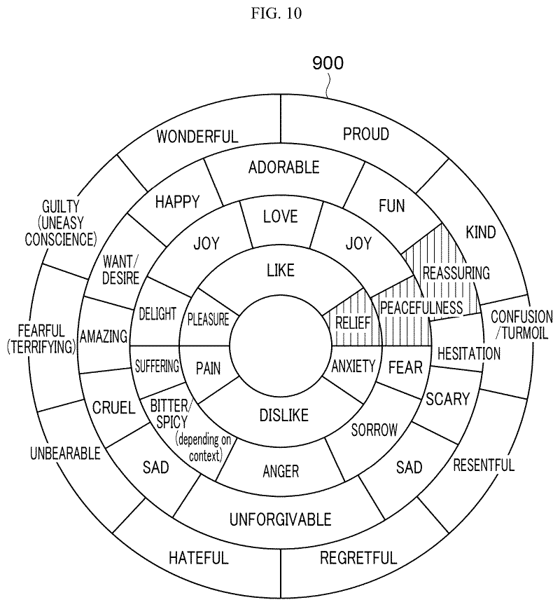

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire, from a terminal, information including a goal and a current situation of a user, and store the information as structured data in a storage device,
classify, based on the structured data, a type of the goal, temporal conditions, and behavior history of the user, and generate a prompt sentence including an input text for a generative AI model,
generate an extended prompt sentence for input to the generative AI model by adding, to the prompt sentence, externally acquired data relating to at least one of location information, calendar information, weather information, route information, learning history information, and progress information of the user,
input the extended prompt sentence into the generative AI model, execute inference processing by the generative AI model, and acquire a generation result including advice information and action plan information according to the goal and the current situation of the user,
analyze the generation result, structure the generation result as at least one of summary information, daily action information, weekly action information, schedule information, resource information, and motivational information, and format the structured result as display data,
transmit the display data to the terminal to cause the terminal to visually present the display data to the user, and
acquire behavior record information and feedback information of the user from the terminal, update contents of the prompt sentence and the extended prompt sentence based on the behavior record information and the feedback information, and use the updated prompt sentence and extended prompt sentence for subsequent inference processing by the generative AI model so as to continuously generate optimized advice information and action plan information for the user.

### Supplementary 2

The system according to supplementary 1,
wherein the processor is configured to
store the generation result as record information in the storage device, perform similarity search or history reference on the record information, and incorporate a past generation result into the prompt sentence to generate advice information and action plan information having continuity for the user.

### Supplementary 3

The system according to supplementary 1,
wherein the processor is configured to
calculate, based on input information and the behavior record information of the user acquired from the terminal, category information and achievement information for each type of goal, and include the category information and the achievement information in the prompt sentence to cause the generative AI model, through the inference processing, to adjust and provide step-by-step guidance adapted to a state of the user.

### Application Example 1

### Supplementary 1

A system comprising a processor,
wherein the processor is configured to
acquire goal information and time information of a user from a terminal, and input the goal information and the time information as text information, and
execute natural language processing on the text information to perform token-level segmentation processing and semantic analysis processing, generate structured information including the goal information and the time information, and generate a prompt sentence including conditions and constraints for achievement of the goal of the user based on the structured information, and
input the prompt sentence to a generative AI model and acquire, from the generative AI model, response text including optimal time usage corresponding to a life schedule and a goal of the user and step-by-step guidance toward achievement of the goal, and
convert the response text into structured data including item information and time allocation information, and format the structured data into a data format transmittable to the terminal via a network, and
distribute the formatted structured data to the terminal and cause the item information and the time allocation information to be visually presented to the user on the terminal.

### Supplementary 2

The system according to supplementary 1,
wherein the processor is configured to
recognize an emotional state of the user by the generative AI model or the natural language processing, and adjust a requested content and a level of detail in the prompt sentence in accordance with the emotional state, thereby adjusting content of the optimal time usage acquired from the generative AI model.

### Supplementary 3

The system according to supplementary 1,
wherein the processor is configured to
recognize an emotional state of the user by the generative AI model or the natural language processing, and adjust instruction expressions and a number of steps in the prompt sentence in accordance with the emotional state, thereby adjusting content of the step-by-step guidance toward achievement of the goal acquired from the generative AI model.

### Example 2

### Supplementary 1

A system comprising a processor,
wherein the processor is configured to
acquire, via an information processing terminal, natural language input information regarding a current situation and an objective of a user, and generate structured text data based on the input information,
generate, based on the structured text data, a prompt sentence for input to a generative AI model, the prompt sentence including a system instruction, user history information, and the input information, and transmit the prompt sentence to the generative AI model,
analyze response text obtained from the generative AI model, and perform data processing on the response text to generate proposal information including a plurality of action steps for achievement of the objective of the user, time allocation corresponding to the action steps, and a daily schedule plan,
convert the proposal information into structured data in which a list of the action steps, time management proposals, and schedule candidates are hierarchically organized or listed, and edit the structured data into a format transmittable to the information processing terminal, and
provide, via the information processing terminal, an interactive interface that presents the proposal information visually or audibly, accepts follow-up natural language input from the user, and iteratively updates the prompt sentence and the proposal information based on the follow-up natural language input.

### Supplementary 2

The system according to supplementary 1,
wherein the processor is configured to
estimate an emotional state or a motivational state of the user based on the response text obtained from the generative AI model and the structured text data, and adjust at least one of a strictness, a load amount, and a concreteness of the time allocation and the daily schedule plan in the proposal information in accordance with an estimation result.

### Supplementary 3

The system according to supplementary 1,
wherein the processor is configured to
reconstruct an existing sequence of the action steps based on the response text obtained from the generative AI model and follow-up input from the user, and dynamically regenerate step-by-step guidance for achievement of the objective of the user by updating at least one of an order, a granularity, and a required time of the action steps in accordance with at least one of a target completion time, an available time period, and a resource constraint.

### Application Example 2

### Supplementary 1

A system comprising a processor,
wherein the processor is configured to
receive, via an information processing terminal, input representing a current state, a goal, a schedule, purchase intention data, or income and expenditure data of a user, and to receive inquiries from the user,
analyze input text information, audio information, image information, or numerical information, and identify an emotional state of the user, goal content, available time, constraint conditions, and behavior history of the user by using a natural language processing technique and an emotion analysis technique,
generate context data representing a user state on the basis of an analysis result and external information acquired by an external information acquisition unit, the external information including schedule information, facility layout information, or income and expenditure history information,
generate a task-specific prompt sentence on the basis of the context data, input the prompt sentence into a generative AI model, and cause the generative AI model to generate guidance information including at least one of a time-management plan, an activity proposal, a purchasing behavior plan, a route plan, or an expenditure plan as step-by-step guidance, execute, on the basis of the guidance information output from the generative AI model and the schedule information, the facility layout information, or the income and expenditure history information acquired by the external information acquisition unit, at least one of a schedule registration process for registering events in schedule data, a movement route calculation process for calculating an in-facility movement route, or a budget calculation process for calculating a budget by expenditure category, and generate guidance information including an optimal usage of time and step-by-step guidance toward goal achievement in accordance with the schedule and the goal of the user,
transmit the guidance information to the information processing terminal and cause the guidance information to be presented to the user by screen display, notification, or audio output, and receive progress input or feedback input from the user, and
regenerate the prompt sentence and execute the generative AI model again on the basis of the progress input or the feedback input and an updated emotional state, and dynamically update the guidance information.

### Supplementary 2

The system according to supplementary 1,
wherein the processor is configured to adjust at least one of the time-management plan, a rest proposal, an activity difficulty level, a task division granularity, or an execution frequency, and to modify the guidance information so as to reduce a burden on the user or to improve motivation of the user, in accordance with the emotional state of the user and a change history thereof estimated by the emotion analysis technique.

### Supplementary 3

The system according to supplementary 1,
wherein the processor is configured to generate the prompt sentence so as to re-divide unexecuted tasks into smaller steps and to reset short-term goals that are easy to achieve, on the basis of the progress input, the behavior history, and the emotional state of the user estimated by the emotion analysis technique, and to update the step-by-step guidance information generated by the generative AI model.

What is claimed is:

1. A system comprising:
circuitry configured to:
receive, via a communication interface coupled to a packet-switched network, input data from a terminal device, the input data including text representing a current situation and an objective of a user;
generate, based on the input data, structured data in which a goal type, temporal conditions, and behavior history of the user are classified;
construct a prompt sentence for a generative neural network model based on the structured data, and generate an extended prompt sentence by augmenting the prompt sentence with externally acquired contextual data;
execute inference processing using the generative neural network model with the extended prompt sentence as input to obtain a generation result including guidance information and action plan information;
structure the generation result as display data and transmit the display data to the terminal device via the communication interface; and
acquire behavior record data and feedback data from the terminal device, update the prompt sentence based on the behavior record data and the feedback data, and perform similarity search on stored record information to incorporate a past generation result into a subsequent prompt sentence.

2. The system according to claim 1, wherein the circuitry is configured to perform token-level segmentation and semantic analysis on the input data to generate the structured data.

3. The system according to claim 2, wherein the circuitry is configured to extract, from the structured data, at least one of a goal category, a deadline parameter, and a constraint condition for embedding in the prompt sentence.

4. The system according to claim 3, wherein the circuitry is configured to embed conditions and constraints derived from the structured data into the prompt sentence as machine-readable text optimized for input to the generative neural network model.

5. The system according to claim 4, wherein the circuitry is configured to generate the extended prompt sentence by adding, to the prompt sentence, at least one of location information, calendar information, weather information, and route information acquired from an external data source.

6. The system according to claim 5, wherein the circuitry is configured to include user history information in the extended prompt sentence, the user history information comprising at least one of learning history records, progress records, and prior generation results associated with the user.

7. The system according to claim 1, wherein the circuitry is configured to structure the generation result into at least two of summary information, daily action information, weekly action information, schedule information, resource information, and motivational information.

8. The system according to claim 7, wherein the circuitry is configured to convert the structured generation result into item information and time allocation information, and format the item information and the time allocation information as the display data for transmission to the terminal device.

9. The system according to claim 8, wherein the circuitry is configured to estimate an affective state of the user based on the input data and the generation result, and adjust at least one of a task load parameter, a step granularity parameter, and a schedule strictness parameter in the action plan information in accordance with the estimated affective state.

10. The system according to claim 9, wherein the circuitry is configured to, when the estimated affective state indicates reduced motivation, reduce the task load parameter and subdivide action steps into smaller granularity steps within the action plan information.

11. The system according to claim 9, wherein the circuitry is configured to, when the estimated affective state indicates elevated stress, insert rest interval entries into the schedule information and prioritize lower-complexity action steps.

12. The system according to claim 1, wherein the circuitry is configured to store the generation result as record information in a storage device, and perform the similarity search by computing a similarity measure between a vector representation of a current prompt sentence and vector representations of stored record information entries.

13. The system according to claim 12, wherein the circuitry is configured to retrieve one or more past generation result entries having similarity measures exceeding a threshold value, and incorporate the retrieved entries into the subsequent prompt sentence to improve coherence of the generated guidance information.

14. The system according to claim 1, wherein the circuitry is configured to calculate category information and achievement information for each classified goal type based on the behavior record data, and include the category information and the achievement information in the prompt sentence to adjust step-by-step guidance generated by the generative neural network model.

15. The system according to claim 14, wherein the circuitry is configured to dynamically update at least one of an ordering, a granularity, and a required time of action steps in the action plan information based on at least one of a target completion time, an available time period, and a resource constraint derived from the feedback data.

16. The system according to claim 1, wherein the circuitry is configured to provide an interactive interface to the terminal device that accepts follow-up natural language input from the user, and iteratively update the prompt sentence and the action plan information based on the follow-up natural language input.

17. The system according to claim 16, wherein the circuitry is configured to reconstruct a sequence of action steps based on the follow-up natural language input and regenerate the step-by-step guidance by updating action step parameters in accordance with updated temporal constraint parameters.

18. A system comprising:
circuitry configured to:
receive, via a communication interface coupled to a packet-switched network, text input data from a terminal device, the text input data describing a current situation and an objective of a user;
execute token-level segmentation and semantic analysis on the text input data to generate structured data classifying a goal type, temporal conditions, and behavior history of the user;
construct a prompt sentence based on the structured data and generate an extended prompt sentence by augmenting the prompt sentence with at least one of location information, calendar information, and weather information acquired from an external data source and with user history information stored in a memory;
execute inference processing using a generative neural network model with the extended prompt sentence as input to obtain a generation result comprising action step data and time allocation data;
structure the generation result into display data comprising item information and schedule information, and transmit the display data to the terminal device via the communication interface; and
receive behavior record data and feedback data from the terminal device, compute a similarity measure between a vector representation of a current prompt sentence and vector representations of stored record information, retrieve stored record entries having similarity measures exceeding a threshold value, and incorporate the retrieved entries into a subsequent prompt sentence for iterative inference processing.

19. The system according to claim 18, wherein the circuitry is configured to estimate an affective state of the user from the text input data using the generative neural network model, and adjust at least one of a task load parameter, a step granularity parameter, and a schedule strictness parameter in the action step data based on the estimated affective state.

20. A method comprising:
receiving, via a communication interface coupled to a packet-switched network, input data from a terminal device, the input data including text representing a current situation and an objective of a user;
generating, based on the input data, structured data in which a goal type, temporal conditions, and behavior history of the user are classified;
constructing a prompt sentence for a generative neural network model based on the structured data, and generating an extended prompt sentence by augmenting the prompt sentence with externally acquired contextual data;
executing inference processing using the generative neural network model with the extended prompt sentence as input to obtain a generation result including guidance information and action plan information;
structuring the generation result as display data and transmitting the display data to the terminal device via the communication interface; and
acquiring behavior record data and feedback data from the terminal device, updating the prompt sentence based on the behavior record data and the feedback data, and performing similarity search on stored record information to incorporate a past generation result into a subsequent prompt sentence.
